(19) United States
(12) Patent Application Publication
(10) Pub. No.: US 2026/0253355 A1
(43) Pub. Date: Aug. 27, 2026

(54) MODIFYING THREE-DIMENSIONAL MODEL QUALITY BY USING COMMON KNOWLEDGE

(71) Applicant: QUALCOMM Incorporated, San Diego, CA (US)

(72) Inventors: Lokesh JAIN, San Diego, CA (US); Satyam GABA, San Diego, CA (US); Parag Mohan KANADE, San Diego, CA (US); Sony AKKARAKARAN, Poway, CA (US); Tao LUO, San Diego, CA (US)

(21) Appl. No.: 19/547,645

(22) Filed: Feb. 23, 2026

Related U.S. Application Data
(60) Provisional application No. 63/763,755, filed on Feb. 26, 2025.

(51) Int. Cl. G06T 19/20; G06T 17/20

(52) U.S. Cl. CPC G06T 19/20; G06T 17/205; G06T 2219/004; G06T 2219/2012; G06T 2219/2016; G06T 2219/2021

(57) ABSTRACT

Methods, systems, and devices for data processing are described. To generate a three-dimensional (3D) model of a scene, a system may obtain, from an original model of the scene, context and scene information associated with a first 2D object included in the scene. The scene may include a geographic area, a second 3D object, or both. The system may generate, in accordance with the context and scene information, an updated model of the first 3D object including first parameters associated with physical properties of the first 3D object that are modified relative to second parameters included in the original model based on modified parameters obtained, from a parametric database, using the context and scene information. The system may output a 3D model associated with the scene and including the updated model of the first 3D object.

### CROSS REFERENCES

The present Application for Patent claims benefit of U.S. Provisional Patent Application No. 63/763,755 by JAIN et al., entitled “THREE-DIMENSIONAL MODEL QUALITY BY USING COMMON KNOWLEDGE,” filed Feb. 26, 2025, which is assigned to the assignee hereof, and expressly incorporated herein.

### FIELD OF TECHNOLOGY

The following relates to data processing, including improving three-dimensional (3D) model quality by using common knowledge.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for three-dimensional model creation by an apparatus is described. The method may include obtaining, from an original model of a scene, context and scene information associated with a first three-dimensional (3D) object included in the scene, the scene including a geographic area, a second 3D object, or both, generating, in accordance with the context and scene information, an updated model of the first 3D object, where the updated model of the first 3D object includes one or more first parameters associated with physical properties of the first 3D object that are modified relative to one or more second parameters included in the original model based on a set of multiple modified parameters obtained, from a parametric database including parametric information associated with a set of multiple candidate objects, using the context and scene information, and outputting a 3D model associated with the scene and including the updated model of the first 3D object.

An apparatus for 3D model creation is described. The apparatus may include a processing system that includes processor circuitry and memory circuitry that stores code. The processing system may be configured to cause the apparatus to obtain, from an original model of a scene, context and scene information associated with a first 3D object included in the scene, the scene including a geographic area, a second 3D object, or both, generate, in accordance with the context and scene information, an updated model of the first 3D object, where the updated model of the first 3D object includes one or more first parameters associated with physical properties of the first 3D object that are modified relative to one or more second parameters included in the original model based on a set of multiple modified parameters obtained, from a parametric database including parametric information associated with a set of multiple candidate objects, using the context and scene information, and output a 3D model associated with the scene and including the updated model of the first 3D object.

Another apparatus for 3D model creation is described. The apparatus may include means for obtaining, from an original model of a scene, context and scene information associated with a first 3D object included in the scene, the scene including a geographic area, a second 3D object, or both, means for generating, in accordance with the context and scene information, an updated model of the first 3D object, where the updated model of the first 3D object includes one or more first parameters associated with physical properties of the first 3D object that are modified relative to one or more second parameters included in the original model based on a set of multiple modified parameters obtained, from a parametric database including parametric information associated with a set of multiple candidate objects, using the context and scene information, and means for outputting a 3D model associated with the scene and including the updated model of the first 3D object.

A non-transitory computer-readable medium storing code for 3D model creation is described. The code may include instructions executable by one or more processors to obtain, from an original model of a scene, context and scene information associated with a first 3D object included in the scene, the scene including a geographic area, a second 3D object, or both, generate, in accordance with the context and scene information, an updated model of the first 3D object, where the updated model of the first 3D object includes one or more first parameters associated with physical properties of the first 3D object that are modified relative to one or more second parameters included in the original model based on a set of multiple modified parameters obtained, from a parametric database including parametric information associated with a set of multiple candidate objects, using the context and scene information, and output 3D model associated with the scene and including the updated model of the first 3D object.

In some examples of the method, apparatus, and non-transitory computer-readable medium described herein, obtaining the context and scene information may include operations, features, means, or instructions for obtaining a type of the first 3D object, a name of the first 3D object, a relative position of the first 3D object within the scene, a physical location of the scene, a type of the scene, or any combination thereof.

In some examples of the method, apparatus, and non-transitory computer-readable medium described herein, generating the updated model of the first 3D object may include operations, features, means, or instructions for generating one or more image segmentation masks associated with the first 3D object based on a set of multiple images of the scene, where the one or more image segmentation masks include labels associated with the first 3D object, obtaining associations between the one or more image segmentation masks and a 3D model associated with the scene, and merging the labels associated with the first 3D object from the one or more image segmentation masks with the 3D model, where the context and scene information indicates whether the context and scene information may be associated with the one or more image segmentation masks or may be associated with the 3D model after merging, and where generating the updated model includes modifying one or more properties of the 3D model after generating the one or more image segmentation masks, after merging the labels associated with the first 3D object with the 3D model, or both based on the context and scene information.

Some examples of the method, apparatus, and non-transitory computer-readable medium described herein may further include operations, features, means, or instructions for transmitting a query to the parametric database, the query including the context and scene information and obtaining, in accordance with the query, the set of multiple modified parameters associated with the physical properties of the first 3D object, where the set of multiple modified parameters includes parameters associated with a shape of the first 3D object, a color of the first 3D object, dimensions of the first 3D object, a type of the first 3D object, a type of material included in the first 3D object, or any combination thereof.

Some examples of the method, apparatus, and non-transitory computer-readable medium described herein may further include operations, features, means, or instructions for transmitting a query to the parametric database, the query including the context and scene information, obtaining, in accordance with the query, the set of multiple modified parameters associated with the physical properties of the first 3D object, and selecting the one or more first parameters from among the set of multiple modified parameters in accordance with a correlation between one or more original parameters associated with the original model of the first 3D object and the one or more first parameters.

In some examples of the method, apparatus, and non-transitory computer-readable medium described herein, generating the updated model of the first 3D object may include operations, features, means, or instructions for removing, supplementing, or adjusting one or more 3D models from the original model of the scene based on the set of multiple modified parameters.

In some examples of the method, apparatus, and non-transitory computer-readable medium described herein, the set of multiple modified parameters indicate that the physical properties of the first 3D object in the original model may be to be modified according to a geometric transformation, one or more deformations, one or more morphological operations, one or more free-form deformations, one or more surface modifications, one or more volumetric modifications, one or more subdividing modifications, one or more redefining modifications, one or more remeshing modifications, one or more decimating modifications, or any combination thereof and the one or more first parameters may be generated based on a modification of the one or more second parameters according to the set of multiple modified parameters

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports improving three-dimensional (3D) model quality by using common knowledge in accordance with one or more aspects of the present disclosure.

FIG. 2 shows an example of a computer vision pipeline that supports improving 3D model quality by using common knowledge in accordance with one or more aspects of the present disclosure.

FIG. 3 shows an example of an object modification timeline that supports improving 3D model quality by using common knowledge in accordance with one or more aspects of the present disclosure.

FIGS. 4 and 5 show block diagrams of devices that support improving 3D model quality by using common knowledge in accordance with one or more aspects of the present disclosure.

FIG. 6 shows a block diagram of a communications manager that supports improving 3D model quality by using common knowledge in accordance with one or more aspects of the present disclosure.

FIG. 7 shows a diagram of a system including a UE that supports improving 3D model quality by using common knowledge in accordance with one or more aspects of the present disclosure.

FIG. 8 shows a diagram of a system including a network entity that supports improving 3D model quality by using common knowledge in accordance with one or more aspects of the present disclosure.

FIG. 9 shows a diagram of a system including a device that supports improving 3D model quality by using common knowledge in accordance with one or more aspects of the present disclosure.

FIGS. 10 and 11 show flowcharts illustrating methods that support improving 3D model quality by using common knowledge in accordance with one or more aspects of the present disclosure.

### DETAILED DESCRIPTION

Various devices may be capable of utilizing visual data to identify and understand objects included within images and video. Such techniques may be referred to as computer vision, which may implement one or more artificial intelligence (AI) and/or machine learning (ML) models and/or functionalities (which may include deep learning and other models/functionalities). Computer vision may refer to techniques including one or more computing devices that replicate the way in which humans see and determine what is being viewed. Computer vision may be based on one or multiple devices (e.g., sensing devices) that are capable of capturing video and/or digital images used (e.g., by one or more servers, which may correspond to cloud computing) as an input to one or more AI/ML models/functionalities for identifying information within the visual data. As an example, information about one or more physical objects in a three-dimensional (3D) scene, which may be a digital representation of the geometry of the one or more physical objects and orientation in 3D space, may be obtained by sensing devices in accordance with one or more techniques. Various algorithms may be used to process the visual data, where such algorithms may be trained on some quantity of information to enable the algorithms to identify patterns in the visual data and identify corresponding content (e.g., objects, structures, individuals). In some cases, image segmentation techniques may be utilized for computer vision, which may include classifying and labeling information (e.g., pixels) within an image.

3D segmentation may generally include labeling various regions of data representing a 3D scene or environment. Segmentation of a 3D model (e.g., a digital surface model, a 3D mesh model) may be important in various applications and technologies relating to 3D models, such as digital twin technologies, extended reality (XR) technologies (e.g., including virtual reality (VR), augmented reality (AR), and/or mixed reality (MR)), gaming, or the like. Additionally, 3D model technologies may include generating up-to-date representations of a real physical object, where a digital twin may further enable simulation and testing of how such objects may perform. As such, digital twin technologies may be used in various industries, including aerospace, automotive, manufacturing, logistics, and medicine. In some examples, a digital twin (e.g., a radio frequency (RF) digital twin) may be generated by mapping RF properties onto a 3D scene, where wireless performance of a corresponding wireless communications system may be simulated using the RF digital twin. Such digital twins may therefore be used to analyze and improve (e.g., optimize) the performance of one or more wireless communications systems, and corresponding simulations may capture phenomena that may affect one or more wireless channels, where such phenomena may include reflection, absorption, scattering by various object of different material types in the scene, among other examples. In any case, 3D model segmentation may enable the segmentation of different components within a 3D scene, allowing for distinct computational processing for each component.

A 3D model creation entity may use input map data of a scene (e.g., a geographic area, an object) to generate a 3D model (e.g., a digital twin, an input for refinement to digital twin generation). Such input map data may be obtained in accordance with lidar-based techniques, radar-based techniques, or depth camera-based techniques. Additionally, or alternatively, such input map data may include data associated with a 3D model of a scene (e.g., obtained from a third-party vendor). Across such various options, the input map data may be based on images or measurements of the scene that are relatively coarse, such as based on a first-order survey. Such relatively coarse data may provide sufficient information for model generation (e.g., for an RF model) for most aspects of an area, but some regions within the area may have relatively incomplete or inaccurate data. For example, 3D models of some geographic areas may be generated using images taken from one or more aerial devices (e.g., a satellite, a drone, or a low-flying airplane) and may have occluded areas that are not visible in the generated images but which may have an impact on a RF model that is based on such imagery. Thus, using a digital twin generated based on first order survey data or measurements of a scene may result in some regions or objects within the scene with an inaccurate representation, which may result in inaccurate simulations (e.g., such that simulation results using the digital twin are dissimilar to actual measurements within a real-world version of the scene). That is, some of the objects within the scene may be identifiable, but such objects may have various irregularities. Thus, techniques for refining the physical properties of known objects within a 3D model based on common knowledge of the objects may be beneficial.

As described herein, techniques may be used to segment respective object types included in a 3D model (e.g., a collection of polygons in a 3D space, a point cloud, a mesh, or the like), label the respective object types, and query a common knowledge database to obtain common physical properties associated with the respective objects. In some examples, a candidate set of values may be obtained from the common knowledge database, and the physical parameters may be selected from the candidate values based on a correspondence with one or more characteristics of the respective objects. The described techniques may provide for modification of one or more 3D objects within a given scene (e.g., a geographical area or another object) based on modified physical parameters received from the common knowledge database, which may be a parametric database. For example, a computer vision pipeline or algorithm may be implemented by one or more devices to obtain a 3D model of a scene and generate a labeled segmented model from the original 3D model. The one or more devices may include a modifier module configured to obtain context and scene information that labels each object, defines the object, and provides contextual information associated with the object (e.g., a location, position, color, description, model, type, date, time, season, or the like). The modifier module may send the context and scene information for a given object within the original model to the parametric database and may obtain multiple potential parameters associated with various physical properties that are expected (e.g., average, likely) for the object given the context. The modifier module may modify the various physical properties of the object within the original model to generate an updated 3D model of the object that more accurately and closely resembles the object in real life.

The described modification may be performed at various steps within the computer vision pipeline for segmented merged model generation. For example, the modifications may be performed after the 3D semantic segmentation (e.g., each segmented object may be modified according to the modified parameters returned from the parametric database). Additionally, or alternatively, the modifications may be performed after respective labels are merged with the objects based on the segmentation. In such cases, the parametric database may return modified parameters associated with material assignments for the object, among other examples.

Particular aspects of the subject matter described in this disclosure may be implemented to realize one or more of the following potential advantages. For example, in accordance with aspects of the present disclosure, the use of the common knowledge database may improve 3D model accuracy, making objects within a 3D module more accurate relative to real-life versions of the objects. Such features may enable relatively high quality dense 3D models of arbitrary shapes and sizes, which may be used for wireless raytracing, among other examples. Some modeling techniques may obtain models of 3D scenes that are relatively coarse, irregular, or otherwise modified relative to the real-world version of the scene, and the described techniques may provide techniques for enhancing such models with relatively low latency and processing. Further, the described modification techniques may be used dynamically for certain regions of interest within an initial model to, for example, improve regions or objects within the model which may have a higher impact on radio frequency simulation outcomes and may thus be prime candidates for repair, such as occluded or obstructed areas or objects. The described techniques may thereby improve physical properties of modeled objects, such as surface, shape, size, color, angles, rotations, textures, materials, or the like. Such techniques may provide higher simulation accuracy with relatively small incremental computational cost, as the parametric database may be queried relatively quickly and may be stored on a server or separate device external to the devices used for simulation. Further, in accordance with the 3D model (e.g., digital twin) providing more accurate simulation results, the 3D model may be used to make better decisions, predictions, or estimations associated with wireless communications within the geographic area, which may facilitate greater system capacity, higher data rates, and greater spectral efficiency, among other benefits.

As used herein, a 3D model can include a digital representation of a 3D scene or object including meshes/surfaces (e.g., polygons with vertices, edges, and faces), point clouds (e.g., x, y, z points, optionally with color or depth), voxels, neural radiance fields, or other 3D formats, and may include information such as colors, textures, materials, coordinates, and camera/scene parameters. A 3D model can also include a digital twin that maps physical properties and behaviors onto 3D representations for simulation and analysis. Further, a scene or 3D scene represented by a 3D model can include a spatially bounded environment including one or more 3D objects and their relationships within a coordinate frame, such as a geographic area (e.g., streets, buildings, vegetation) or object-centric setting, and may be represented by any 3D model format (e.g., meshes, point clouds, voxels, neural radiance fields, or a digital twin) with associated colors, textures, materials, and camera/scene parameters such as contextual metadata such as time, location, and type.

Aspects of the disclosure are initially described in the context of wireless communications systems. Additional aspects of the disclosure are described with reference to object modification timelines. Aspects of the disclosure are further illustrated by and described with reference to apparatus diagrams, system diagrams, and flowcharts that relate to modifying (e.g., improving) 3D model quality by using common knowledge.

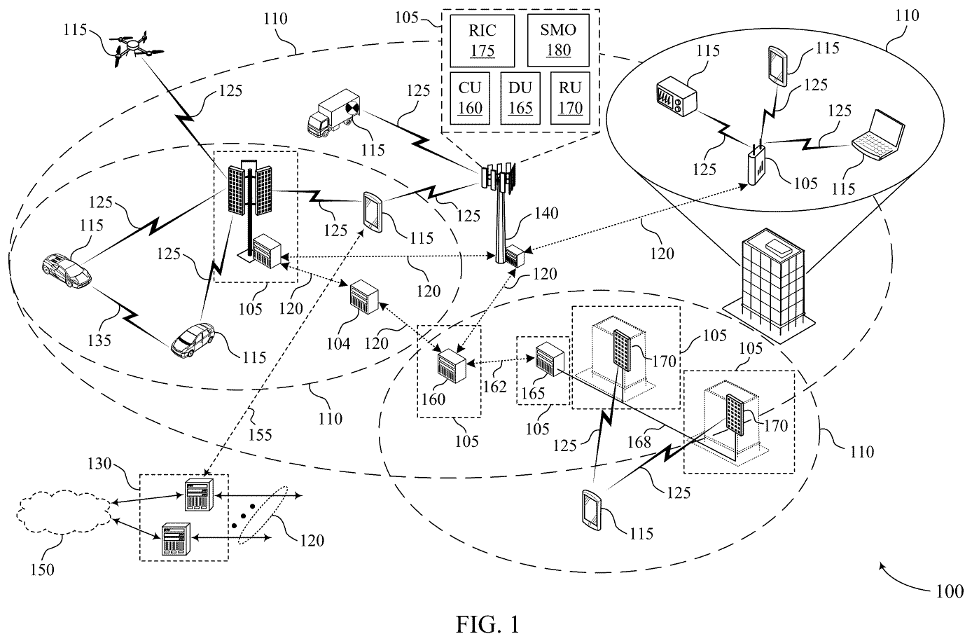

FIG. 1 shows an example of a wireless communications system 100 that supports improving 3D model quality by using common knowledge in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support improving 3D model quality by using common knowledge as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may support one or more computer vision pipelines that are implemented (e.g., by one or multiple devices, such as computing devices) to enable accurate and detailed generation of various 3D models (e.g., of any 3D model). For example, techniques may be used to segment respective object types included in a 3D model, label the respective object types, and query a common knowledge database to obtain common physical properties associated with the respective objects. The described techniques may provide for modification of one or more 3D objects within a given scene (e.g., a geographical area or another object) based on modified physical parameters received from the common knowledge database, which may be a parametric database. For example, a computer vision pipeline or algorithm may be implemented by one or more devices to obtain a 3D model of a scene and generate a labeled segmented model from the original 3D model. The one or more devices may include a modifier module configured to obtain context and scene information that labels each object, defines the object, and provides contextual information associated with the object (e.g., a location, position, color, description, model, type, date, time, season, or the like). The modifier module may send the context and scene information for a given object within the original model to the parametric database and may obtain multiple potential parameters associated with various physical properties that are expected (e.g., average, likely) for the object given the context. The modifier module may modify the various physical properties of the object within the original model to generate an updated 3D model of the object that more accurately and closely resembles the object in real life. In some examples, a candidate set of values may be obtained from the common knowledge database, and some physical parameters may be selected from the candidate values, where such selection may be based on a correspondence between the physical parameters and one or more characteristics of respective objects.

The described modifications may be performed at various steps within the computer vision pipeline for segmented merged model generation. For example, the modifications may be performed after the 3D semantic segmentation (e.g., each segmented object may be modified according to the modified parameters returned from the parametric database). Additionally, or alternatively, the modifications may be performed after respective labels are merged with the objects based on the segmentation. In such cases, the parametric database may return modified parameters associated with material assignments for the object, among other examples. In some aspects, the described techniques may be used to generate a 3D model (e.g., digital twin), for example, to simulate various aspects of wireless communications within the wireless communications system 100, which may enable various enhancement and improvements to the associated communications.

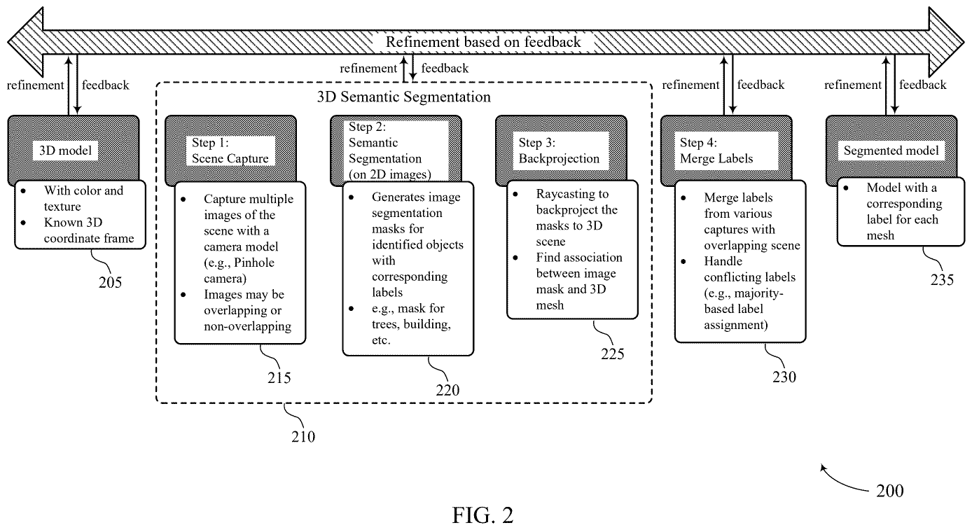

FIG. 2 shows an example of a computer vision pipeline 200 that supports improving 3D model quality by using common knowledge in accordance with one or more aspects of the present disclosure. The computer vision pipeline 200 may implement, or be implemented by, one or more aspects of the wireless communications system 100. In some aspects, the computer vision pipeline 200 may support techniques for the generation of labeled and segmented 3D models (e.g., 3D meshes) with increased accuracy.

Various devices may be capable of utilizing visual data to identify and understand objects included within images and video. Such techniques may be referred to as computer vision, which may implement one or more AI and/or ML models and/or functionalities (which may include deep learning and other models/functionalities). Computer vision may refer to techniques by which one or more computing devices replicate the way in which humans see and determine what is being viewed. Computer vision may be based on one or multiple devices (e.g., sensing devices) that are capable of capturing video and/or digital images and used (e.g., by one or more servers, which may correspond to cloud computing) as an input to one or more AI/ML models/functionalities for identifying information within the visual data. As an example, information about one or more physical objects in a 3D scene, which may be a digital representation of the geometry of the one or more physical objects and orientation in 3D space, may be obtained by sensing devices in accordance with one or more techniques. Such techniques may include photogrammetry (e.g., utilizing multiple overlapping images from different angles), imaging via stereo cameras (e.g., using cameras having two or more lenses with separate image sensors), light detection and ranging (LiDAR) and other remote sensing technologies, laser scanning (e.g., for measuring distances to various points on an object and creating a point cloud), structured light technologies (e.g., projecting a pattern of light and using distortion to determine shapes), computed tomography (e.g., using x-rays to obtain images of internal structures), among other examples. Various algorithms may be used to process the visual data, where such algorithms may be trained on some quantity of information to enable the algorithms to identify patterns in the visual data and identify corresponding content (e.g., objects, structures, individuals).

In some cases, image segmentation techniques (e.g., zero-shot segmentation) may be utilized for computer vision based on scalability and adaptability associated with such techniques. Image segmentation may include classifying and labeling information (e.g., pixels) within an image. Some foundation models (e.g., large-scale neural network architectures pre-trained on large datasets), such as a SAM, may perform query-based segmentation on images. Using such models, masks may be automatically generated to segment all of the objects included in an image, where a mask may be a two-dimensional (2D) matrix having binary entries (e.g., a binary 2D matrix) having a same spatial dimension as an input image, and each element (e.g., M(i, j)) of the matrix may indicate a presence (e.g., 1) or absence (e.g., 0) of a specific object or region at some pixel location (e.g., i, j).

3D scenes may be represented in various formats, including point cloud formats and mesh/surface formats. A 3D point cloud may be a 3D data representations of the world captured via one or more sensing devices, which may include a collection of individual points defined by x, y, and z coordinates. 3D meshes may be models comprising vertices, edges, and faces that correspond to polygons (e.g., triangles, quadrilaterals) representing 3D objects, and such techniques may be relatively more prevalent in the gaming, film, and design industries. Point clouds may be associated with relatively increased accuracy and detailed representations of scenes, but may also be associated with relatively slow rendering operations and/or increased processing requirements. Meshes/surfaces may be associated with relatively faster rendering operations, improved manipulation of visual data, and improved aesthetic representation.

In some cases, however, there may not be any well-established foundation models for direct 3D mesh segmentation. 3D segmentation may generally include labeling of various regions of data representing a 3D scene or environment. As an example, an input for 3D segmentation may include a 3D model showing one or more structures through respective surfaces of such structures, a 3D model showing the one or more structures including the respective surfaces and color, or both. In some cases, inputs for 3D image segmentation may include unsegmented 3D models having, for example, N 3D surfaces (which may be called meshes, faces, polygons, or other similar terminology) and color. An output of the 3D segmentation may include a 3D segmented model, such as a 3D model showing structures via multiple segments, which may have some quantity of segments (e.g., the quantity of segments, K, may be less than a quantity of 3D surfaces (e.g., K<<N)), the N 3D surfaces (retained from the input), the color (retained from the input), and a respective label for each mesh. Segmentation of a 3D mesh (e.g., a digital surface model) may be important in various applications and technologies relating to 3D models, such as digital twin technologies, XR technologies (e.g., including VR, AR, and/or MR), gaming, or the like). In some cases, 3D model technologies may include generating up-to-date representations of a real physical object, where a digital twin may further enable simulation and testing of how such objects may perform. As such, digital twin technologies may be used in various fields, including aerospace, automotive, manufacturing, logistics, and medicine. In any case, 3D mesh segmentation may enable the segmentation of different components within a 3D scene, allowing for distinct computational processing for each component.

In some examples, a digital twin (e.g., a radio frequency (RF) digital twin) may be generated by mapping RF properties onto a 3D scene, where wireless performance of a corresponding wireless communications system may be simulated using the RF digital twin. Such digital twins may therefore be used to analyze and improve (e.g., optimize) the performance of one or more wireless communications systems. For example, ray tracing may be used to simulate wireless signal reception at one or more locations within the 3D scene, where the wireless signals may be simulated as being transmitted from a respective transmitter (e.g., a transmitting wireless communication device, such as one or more network entities 105 or UEs 115). Such simulations may capture phenomena that may affect one or more wireless channels, where such phenomena may include reflection, absorption, scattering by various object of different material types in the scene, among other examples. Simulations achieved by generating the RF digital twin for different wireless communications systems may accordingly facilitate near-real-life wireless simulation and performance evaluations.

Some techniques for 3D mesh segmentation, such as frameworks that predict masks in point clouds (such as SAM3D), may be implemented for 3D point clouds that are segmented. The segmentation of such point clouds may be achieved by clustering points of the 3D point cloud into distinct semantic parts that represent surfaces, objects, and/or structures in an environment. The mesh may then be reconstructed from the point cloud after segmentation. However, reconstruction of the mesh from the point cloud may introduce losses and, as a result, real-life results may not match predictions using the corresponding digital twin.

As described herein, techniques may be used to segment respective object types included in a 3D mesh (e.g., a collection of polygons in a 3D space), which may avoid lossy reconstruction of the mesh from a point cloud. For example, a computer vision pipeline or algorithm may be implemented by one or more devices to obtain a 3D model of a scene (205), perform 3D semantic segmentation (210), perform backprojection (225), merge respective labels based on the segmentation (230), and generate a labeled segmented model based on the merged labels (235). In some aspects, the 3D model obtained as an input may include colors and textures, and may be associated with a coordinate frame (e.g., a known coordinate frame). In some aspects, the 3D model may be an unsegmented 3D mesh that may include one or more views (such as a 3D mesh color view, a 3D mesh skeleton view, and/or a 3D mesh surface view, among other examples).

The 3D semantic segmentation techniques described herein may include scene capture, semantic segmentation, and backprojection techniques (210). For example, the scene capture techniques may include capturing multiple images (e.g., multiple unsegmented 2D images) of a scene associated with the 3D model (215). In some examples, the respective images may be captured using one or more camera models, such as a pinhole camera model or other models, and the images may be overlapping or non-overlapping. The computer vision pipeline 200 may then perform segmentation (e.g., semantic segmentation) for the multiple images (e.g., on the 2D images) (220). Here, semantic segmentation may be performed for each unsegmented 2D image of the multiple 2D images. In some aspects, the segmentation performed on the images may generate a set of image segmentation masks for one or more identified objects having corresponding labels (e.g., window, façade, tree, fountain, bench, or the like). For instance, the set of image segmentation masks may include a mask for trees, a mask for buildings, or the like, for a particular scene. For the backprojection operations (225), one or more raycasting procedures may be performed to backproject the masks to the 3D scene. Raycasting may refer to the use of virtual rays (e.g., virtual light rays) with 3D images, where the rays may intersect with one or more objects in a 3D scene, and some information may be determined based on these intersections. In such cases, associations between an image mask and a 3D mesh may be identified.

Following the 3D semantic segmentation, labels may be merged (230). For instance, respective labels from various captures associated with an overlapping scene may be merged. In some aspects, one or more conflicting labels may be handled by the algorithm, for example, using majority based label assignment (e.g., where a data point may be assigned a label based on a “majority vote” of predicted labels from multiple sources). In any case, the backprojection and merging may result in a labeled and segmented 3D mesh including the various labels (e.g., window, façade, foliage, bench, sidewalk, tree, among other examples). As such, the segmented model may be generated after the labels are merged (235), and the segmented model may be a model with a corresponding label for each mesh. In some aspects, one or more feedback and/or refinement processes may be used with the techniques described herein. For example, refinement and/or feedback may be implemented to modify one or more portions of the computer vision pipeline, including, for example, for the input 3D model, for the 3D semantic segmentation, for merging labels, and for generating the segmented model.

3D scenes associated with computer vision may be represented in various formats, including point cloud formats and mesh/surface formats. A 3D point cloud may be a 3D data representations of the world captured via one or more sensing devices, which may include a collection of individual points defined by x, y, and z coordinates. 3D meshes may be models comprising vertices, edges, and faces that correspond to polygons (e.g., triangles, quadrilaterals) representing 3D objects, and such techniques may be relatively more prevalent in the gaming, film, and design industries. Point clouds may be associated with relatively increased accuracy and detailed representations of scenes, but may also be associated with relatively slow rendering operations and/or increased processing requirements. Meshes/surfaces may be associated with relatively faster rendering operations, improved manipulation of visual data, and improved aesthetic representation.

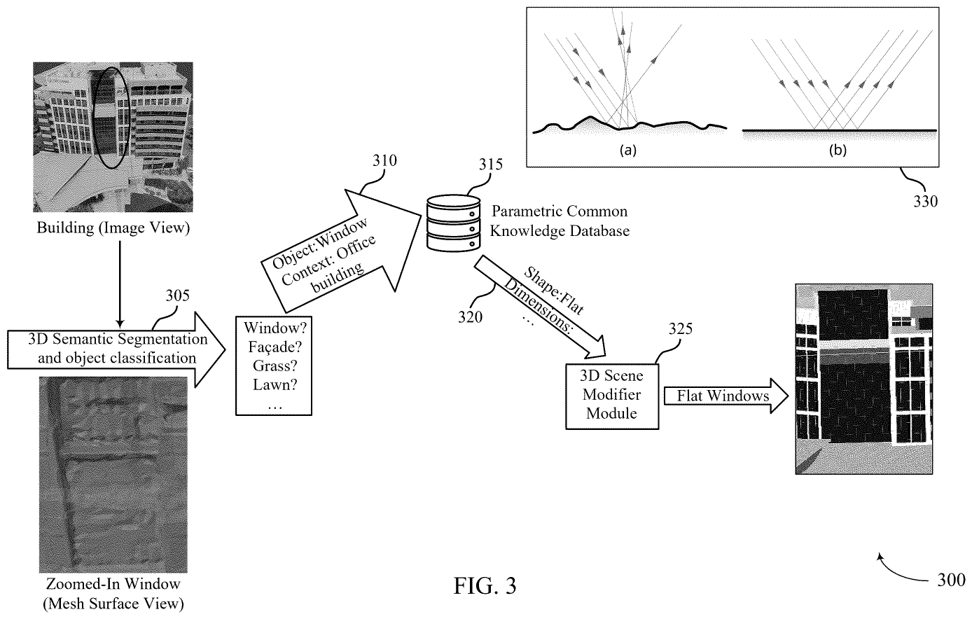

FIG. 3 shows an example of an object modification timeline 300 that supports improving 3D model quality by using common knowledge in accordance with one or more aspects of the present disclosure. The object modification timeline 300 may implement or be implemented by aspects of the wireless communications system 100 and the computer vision pipeline as described with reference to FIGS. 1 and 2. In the example of FIG. 3, a device (e.g., a UE 115, a network entity 105, a node, a server, or some other device), may use a common knowledge database to improve quality of 3D models. A 3D model as described herein may include a point cloud, a mesh, a voxel, a neural radiance field, an octree, another 3D model representation format, or any combination thereof.

The object modification timeline 300 may be associated with a process of modeling a scene for wireless ray tracing, as described with reference to FIG. 2. For example, the device may obtain one or more images of a 3D model of a scene. The scene may be a geographical area, an object, or both. In the example of FIG. 3, the one or more images may be of an office building (e.g., a geographical area), and may be two-dimensional images taken of a 3D model. To begin modeling the office building in 3D using 3D models, at 305, the device may perform semantic segmentation and object classification on the one or more 2D images. That is, the device may segment the images to generate one or more image segmentation masks for identified objects within the image. The image segmentation masks may include or otherwise be associated with respective labels of the objects (e.g., a building label). Computer vision may be capable of identifying, segmenting, and classifying objects in a 3D scene. The semantic segmentation may be performed using machine learning, a manual segmentation, or both. The scene may be, for example, an office park or an office building, and the object may be a window, a door, or the like within the overall scene. Additionally, or alternatively, the scene may be, for example, a brain, and the object may be a tumor within the brain. The scene may thereby be a geographical area (e.g., a park, a parking lot, a street, or the like), or an object (e.g., a brain, a building, a car, or the like) and the scene may include at least one other 3D object that can be segmented from the overall scene.

In the example of FIG. 3, the device may segment a portion of the image of the building that includes an irregular window. As can be seen in the mesh view of the window in FIG. 3, the 3D representation (e.g., map or model) of the building and the window may include one or more irregular and incorrect features. For example, the windows may have a textured surface in the 3D representation. Although it may be well known that most windows in the real world are flat, the 3D representation of the window may not be flat, which may result in some inaccuracies when the 3D representation is used for wireless raytracing, among other examples. For example, the surface reflection model 330 illustrates how signals may be diffused in varying directions when a surface is textured, as in example (a), and the same signals may be reflected differently when the surface is flat or smooth, as in example (b). Accordingly, techniques for improving the accuracy of the 3D models of various objects may be beneficial to improve ray tracing capabilities and performance.

As described herein, the device may include, in the computer vision pipeline for generation of a 3D model of a scene, one or more processes to access a parametric common knowledge database 315 using context and scene information obtained from one or more images, segments, masks, or the like. The parametric common knowledge database 315 may return one or more modified parameters 320 that indicate modifications to parameters defining physical properties of a given 3D object within the 3D scene. That is, the device may use semantic understanding of the object to look up shape and surface properties, among other properties associated with the object, from the parametric common knowledge database 315. The device may refine various physical properties of the object, such as the shape and surfaces of the object, in the 3D scene to reflect the common knowledge. The described techniques may improve accuracy in 3D modeling of objects, which may reduce differences between the real world and 3D models of the real world that are used for wireless raytracing, among other examples.

Accordingly, after performing the semantic segmentation at 305, the device may obtain one or more context and scene parameters associated with one or more objects in a 3D scene. For example, the device may segment each object, and may determine a type of each object using machine learning or manual segmentation. The device may assign a label to each object. The labels may include, among many other examples, a window, a façade, grass, a lawn, or the like. That is, the labels may define what the object is. The device may similarly obtain context information associated with the object, such as a geographic location of the object, a relative position of the object within the rest of the scene, a label for the scene itself, a date, time, or season associated with the representation of the object, or the like. In the example of FIG. 3, the window may be segmented from the remainder of the office building, and the context and scene information 310 may specify that the object is a window and the context is an office building. In some examples, there may be additional context and scene information 310 obtained, such as a general shape of the window, a geographical location of the office building, a relative location of the window within the building, or the like.

The device may input the context and scene information 310 into a parametric common knowledge database 315. For example, the device may query the parametric common knowledge database 315 with the context and scene information 310. The query may include a request for additional information about physical properties of other similar objects having the same or similar context and scene information 310. With reference to FIG. 3, the device may query the parametric common knowledge database 315 to request any information associated with average physical properties of a window in an office building. The parametric common knowledge database 315 may be within the device, coupled with the device, or otherwise accessible to the device (e.g., via a wireless cellular or internet connection). In some examples, the device may query the parametric common knowledge database 315 for one or more objects based on the objects satisfying some conditions or thresholds for modification. That is, if the physical properties of an object as included in an original model are sufficiently distorted, irregular, or otherwise difficult to detect, the device may provide the context and scene information 310 for that object to the parametric common knowledge database 315. Additionally, or alternatively, the device may provide context and scene information 310 for each object included in an original 3D model.

The parametric common knowledge database 315 may return, to a modifier module 325 of the device, for example, multiple modified parameters 320 in response to the query. The modified parameters 320 may include an expected 3D shape, expected dimensions, expected colors, expected types, or the like associated with the object. For example, the modified parameters 320 may indicate that a window in an office building may be expected to be flat and rectangular, or some other information.

In some examples, the parametric common knowledge database 315 may provide multiple expected values for a same parameter, and each value may be associated with a respective likelihood. For example, if the object is a watermelon, the parametric common knowledge database 315 may return an expected shape of a spheroid. If, however, the context and scene information 310 indicates that the object is a watermelon that is located in Japan, the parametric common knowledge database 315 may return modified parameters 320 that indicate an expected spheroidal shape with a first likelihood and an expected cuboidal shape with a second non-zero likelihood, as watermelons may be sold in cuboidal shapes in Japan, whereas in other countries, the likelihood of a cuboidal watermelon may be close to zero. Accordingly, the context and scene information 310 may affect the outputs from the parametric common knowledge database 315.

If multiple values of a given modified parameter 320 are returned, the modifier module 325 may identify values of the same parameter for the detected object in the original model, and may use those values to select one value from among the multiple candidate values of the modified parameter 320 that were returned. In some examples, the selection by the modifier module 325 may be random. Additionally, or alternatively, the modifier module 325 may compare the candidate values for the parameter that were returned from the parametric common knowledge database 315 to the values for the parameter as obtained from the images and the semantic segmentation at 305. The modifier module 325 may select a value, from among the multiple values indicated by the parametric common knowledge database 315, based on the value being most correlated with the values of the parameter in the original model of the original object. For example, if the original object is a watermelon, and the original shape is most correlated with a cuboidal shape, the modifier module 325 may select the cuboidal shape.

The modifier module 325 may thereby obtain (e.g., or select) one or more values for multiple modified parameters 320 associated with modifications to physical properties of the object. The modifier module 325 may modify the detected object's parameters based on the values received from the parametric common knowledge database 315. In some examples, the modifications may include performing one or more modification operations on the object. The modifier module 325 may modify or otherwise adjust one or more parameters of a 3D model (e.g., a mesh, a point cloud, or the like) of the object.

The modifier module 325 may perform various modifications to modify the physical properties of the object according to the modified parameters 320. The modifications may include geometric transformations, deformations, morphological operations, free-form deformations, surface modifications, volumetric modifications, subdividing modifications, redefining modifications, remeshing modifications, decimating modifications, or any combination thereof.

A geometric transformation to a 3D model of an object may include, for example, translation of the object (e.g., moving an object in 3D space without changing the object's orientation or size), rotation of the object (e.g., rotation of the object around a specific axis or point), scaling of the object (e.g., uniformly resizing the object in all directions), shearing of the object (e.g., sliding the object along a plane, changing the object's shape), reflection of the object (e.g., mirroring the object across a plane), or any combination thereof. A deformation to a 3D model of an object may include, for example, bending the object (e.g., curving the object along a specific axis), twisting the object (e.g., rotating the object around a specific axis while keeping one end fixed), stretching the object (e.g., elongating the object in a specific direction), compressing the object (e.g., reducing the size of the object in a specific direction), tapering the object (e.g., gradually changing the size of an object along a specific axis), or any combination thereof.

A morphological operation to a 3D model of an object may include, for example, morphing one or more aspects of the model that may appear in different dimensions (e.g., a 2D portion) via an extrusion (e.g., creating a 3D object by extending a 2D shape along a specific axis), revolution (e.g., creating a 3D object by rotating a 2D shape around a specific axis), sweeping (e.g., creating a 3D object by moving a 2D shape along a specific path), lofting (e.g., creating a 3D object by interpolating between multiple 2D shapes), Boolean operations (e.g., combining multiple 3D objects using union, intersection, or difference operations), or any combination thereof.

A free-form deformation to a 3D model of an object may include, for example, a B-spline deformation (e.g., deformation of the object using a B-spline curve or surface), a non-uniform rational B-spline (NURBS) deformation (e.g., deformation of the object using a NURBS curve or surface), a lattice deformation (e.g., deformation of the object by manipulating a lattice structure that defines the object's shape), skinning of the object (e.g., deformation of the object by manipulating a skin that defines the object's surface), morphing of the object (e.g., gradually transforming one object into another by interpolating between their shapes), or any combination thereof.

A surface modification to a 3D model of an object may include, for example, offsetting (e.g., creating a new surface by offsetting an existing surface by a specified distance), thickening (e.g., adding thickness to a surface or object), thinning (e.g., reducing the thickness of a surface or object), filleting (e.g., smoothing the intersection between two surfaces), chamfering (e.g., cutting a 45-degree angle at the intersection between two surfaces), or any combination thereof. A volumetric modification to a 3D model of an object may include, for example, hallowing the object (e.g., creating a hollow object by removing material from the interior), filling the object (e.g., filling a hollow object with material), drilling (e.g., creating a hole in the object), tunneling (e.g., creating a tunnel or channel through the object), sculpting (e.g., modifying the shape of the object by adding or removing material), smoothing the object (e.g., reducing the noise or irregularities in an object's surface), refining the object (e.g., improving the accuracy or detail of the object's surface), or any combination thereof. Various other modifications to a 3D model of an object may include, for example, decimating (e.g., reducing a quantity of polygons or vertices in the object's mesh), subdividing (e.g., increasing a quantity of polygons or vertices in the object's mesh), remeshing (e.g., rebuilding the object's mesh to improve its quality or topology), or any combination thereof.

The modifier module 325 may thereby perform a variety of modifications as described herein based on the modified parameters 320 to modify one or more physical properties of the original 3D model of the 3D object to arrive at an updated model of the 3D object. In some examples, if the original shape of the window as detected is not a perfect rectangle, but the modified parameters 320 indicate that the window is very likely perfectly rectangular (e.g., based on the context and scene information 310), the modifier module 325 may scale one or more sides of the window in the 3D model to align more closely with the real-life window. The modifier module 325 may additionally, or alternatively, flatten one or more aspects of the 3D model representing the object. For example, if the window as detected has a bumpy or jagged surface, and the modified parameters 320 indicate that the window surface is likely smooth, the modifier module 325 may flatten the model to generate a smooth window surface (e.g., by performing a low pass filter over a normal of the model corresponding to the irregular window). The modifier module 325 may supplement to the 3D model of the object, in some examples. For example, if the detected object is a van, and the modified parameters 320 indicate that the model of the van is likely to have bumpers, but the detected model of the van does not include bumpers, the modifier module 325 may add one or more bumpers to the van (e.g., by adding extrusions to the model). In some examples, the modifier module 325 may rotate the 3D model of the object. For example, if the detected object is the van, and the angle of a windshield on the van is irregular or otherwise off-set relative to the body of the van, the modified parameters 320 may indicate an expected windshield angle, and the modifier module 325 may rotate aspects of the 3D model of the van that correspond to the windshield in order to correct the windshield angle.

The modifier module 325 may thereby modify one or more aspects of the mesh model of objects detected during the semantic segmentation of the 3D model using the modified parameters 320 that are output from the parametric common knowledge database 315. In the example of FIG. 3, the detected object may be a window, and the modifier module 325 may modify various physical properties of the window in order to make the 3D mesh of the window relatively more accurate and closer to the real-life version of the window. In another example, the device may detect a van in one or more images. The device may input, via the context and scene information 310, the label of the object (e.g., the van) and context information associated with the van, such as a type of the van (e.g., a 15-seater van), a location of the van, whether the van includes any open doors, whether the van is parked, and the like. The parametric common knowledge database 315 may return one or more modified parameters 320. For example, the modified parameters 320 may indicate an expected shape of the van, expected dimensions of the van, expected body style of the van, and the like. The modifier module 325 may modify the irregular (e.g., warped) version of the van as originally detected to more accurately represent a real-like example of a 15-seater van.

In some other examples, the detected object may be a tree. However, as detected, the tree may be missing a trunk in the original detected model. The device may be able to determine the context and scene information 310 for the tree using a machine learning or computer vision model. For example, the context and scene information 310 may include that the object is a tree, a season (e.g., fall), a type of the tree (e.g., a palm tree), a location of the tree, and one or more other features associated with the tree. The parametric common knowledge database 315 may output expected values for a shape and size of a palm tree in the fall in the identified location. For example, the modified parameters 320 may indicate an expected trunk for the tree. The modifier module 325 may modify the original 3D mesh for the tree to include a trunk.

The modifier module 325 may perform the modifications to the objects in a 3D scene after the semantic segmentation of the 3D scene at 305 (e.g., after step 2 in FIG. 2). Additionally, or alternatively, the modifier module 325 may perform modifications to the objects in the 3D scene after a material assignment step within a vision pipeline (e.g., after step 4 in FIG. 2). For example, after generating multiple image segmentation masks, the device may perform backprojection operations for each image segmentation mask to identify a correspondence between respective pixels in each image segmentation mask and respective objects of the 3D mesh. The device may merge labels from each image segmentation mask based on the correspondence to associate objects within the 3D mesh to respective labels. At the merge stage within the vision pipeline, the device may, in some examples, assign materials to various objects. Accordingly, the described 3D scheme modification techniques may be applied after the material assignments to modify material properties of the objects as well. As an example, if the detected object is a van, the modifier module 325 may use the modified parameters 320 from the parametric common knowledge database 315 to determine to apply a metal material to the body of the van and a glass material to the windows of the van.

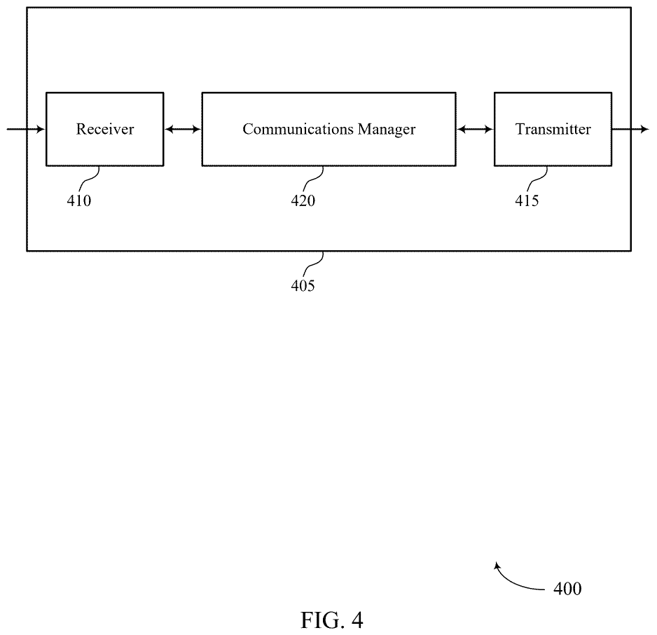

FIG. 4 shows a block diagram 400 of a device 405 that supports improving 3D model quality by using common knowledge in accordance with one or more aspects of the present disclosure. The device 405 may be an example of aspects of a UE 115, a network entity 105, or a computing device as described herein. The device 405 may include a receiver 410, a transmitter 415, and a communications manager 420. The device 405, or one or more components of the device 405 (e.g., the receiver 410, the transmitter 415, the communications manager 420), may include at least one processor, which may be coupled with at least one memory, to, individually or collectively, support or enable the described techniques. Each of these components may be in communication with one another (e.g., via one or more buses).

The receiver 410 may provide a means for receiving information such as packets, user data, control information, or any combination thereof associated with various information channels (e.g., control channels, data channels, information channels related to improving 3D model quality by using common knowledge). Information may be passed on to other components of the device 405. The receiver 410 may utilize a single antenna or a set of multiple antennas.

The transmitter 415 may provide a means for transmitting signals generated by other components of the device 405. For example, the transmitter 415 may transmit information such as packets, user data, control information, or any combination thereof associated with various information channels (e.g., control channels, data channels, information channels related to improving 3D model quality by using common knowledge). In some examples, the transmitter 415 may be co-located with a receiver 410 in a transceiver module. The transmitter 415 may utilize a single antenna or a set of multiple antennas.

The communications manager 420, the receiver 410, the transmitter 415, or various combinations or components thereof may be examples of means for performing various aspects of improving 3D model quality by using common knowledge as described herein. For example, the communications manager 420, the receiver 410, the transmitter 415, or various combinations or components thereof may be capable of performing one or more of the functions described herein.

In some examples, the communications manager 420, the receiver 410, the transmitter 415, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 420, the receiver 410, the transmitter 415, or various combinations or components thereof may be implemented in code (e.g., as communications management software or firmware) executed by at least one processor (e.g., referred to as a processor-executable code). If implemented in code executed by at least one processor, the functions of the communications manager 420, the receiver 410, the transmitter 415, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 420 may be configured to perform various operations (e.g., receiving, obtaining, monitoring, outputting, transmitting) using or otherwise in cooperation with the receiver 410, the transmitter 415, or both. For example, the communications manager 420 may receive information from the receiver 410, send information to the transmitter 415, or be integrated in combination with the receiver 410, the transmitter 415, or both to obtain information, output information, or perform various other operations as described herein.

Additionally, or alternatively, the communications manager 420 may support 3D model creation in accordance with examples as disclosed herein. For example, the communications manager 420 is capable of, configured to, or operable to support a means for obtaining, from an original model of a scene, context and scene information associated with a first 3D object included in the scene, the scene including a geographic area, a second 3D object, or both. The communications manager 420 is capable of, configured to, or operable to support a means for generating, in accordance with the context and scene information, an updated model of the first 3D object, where the updated model of the first 3D object includes one or more first parameters associated with physical properties of the first 3D object that are modified relative to one or more second parameters included in the original model based on a set of multiple modified parameters obtained, from a parametric database including parametric information associated with a set of multiple candidate objects, using the context and scene information. The communications manager 420 is capable of, configured to, or operable to support a means for outputting a 3D model associated with the scene and including the updated model of the first 3D object.

By including or configuring the communications manager 420 in accordance with examples as described herein, the device 405 (e.g., at least one processor controlling or otherwise coupled with the receiver 410, the transmitter 415, the communications manager 420, or a combination thereof) may support techniques for reduced processing, reduced power consumption, and more efficient utilization of resources, among other examples.

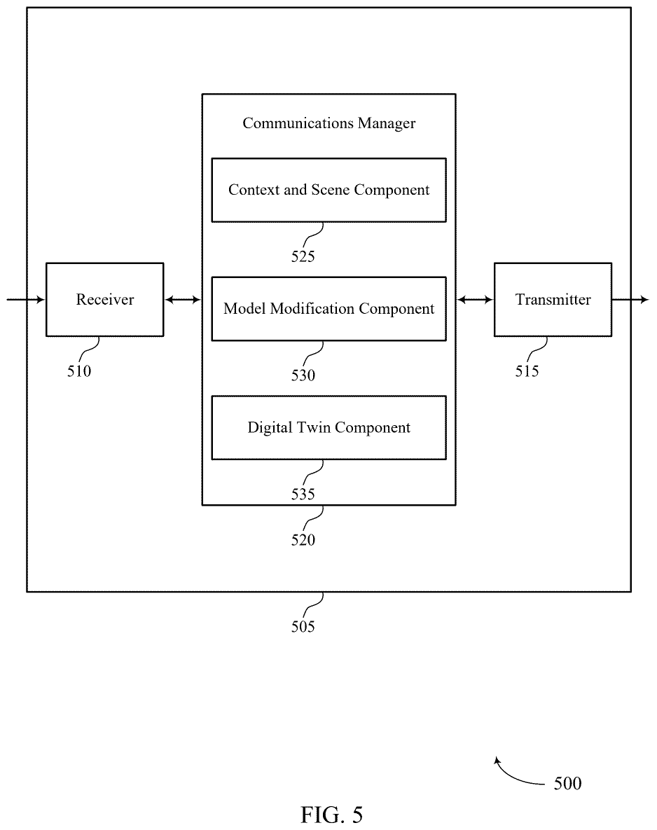

FIG. 5 shows a block diagram 500 of a device 505 that supports improving 3D model quality by using common knowledge in accordance with one or more aspects of the present disclosure. The device 505 may be an example of aspects of a device 405, a UE 115, a network entity 105, or a computing device as described herein. The device 505 may include a receiver 510, a transmitter 515, and a communications manager 520. The device 505, or one or more components of the device 505 (e.g., the receiver 510, the transmitter 515, the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to improving 3D model quality by using common knowledge). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to improving 3D model quality by using common knowledge). In some examples, the transmitter 515 may be co-located with a receiver 510 in a transceiver module. The transmitter 515 may utilize a single antenna or a set of multiple antennas.

The device 505, or various components thereof, may be an example of means for performing various aspects of improving 3D model quality by using common knowledge as described herein. For example, the communications manager 520 may include a context and scene component 525, a model modification component 530, a digital twin component 535, or any combination thereof. The communications manager 520 may be an example of aspects of a communications manager 420 as described herein. In some examples, the communications manager 520, or various components thereof, may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support 3D model creation in accordance with examples as disclosed herein. The context and scene component 525 is capable of, configured to, or operable to support a means for obtaining, from an original model of a scene, context and scene information associated with a first 3D object included in the scene, the scene including a geographic area, a second 3D object, or both. The model modification component 530 is capable of, configured to, or operable to support a means for generating, in accordance with the context and scene information, an updated model of the first 3D object, where the updated model of the first 3D object includes one or more first parameters associated with physical properties of the first 3D object that are modified relative to one or more second parameters included in the original model based on a set of multiple modified parameters obtained, from a parametric database including parametric information associated with a set of multiple candidate objects, using the context and scene information. The digital twin component 535 is capable of, configured to, or operable to support a means for outputting a digital twin associated with the scene and including the updated model of the first 3D object.

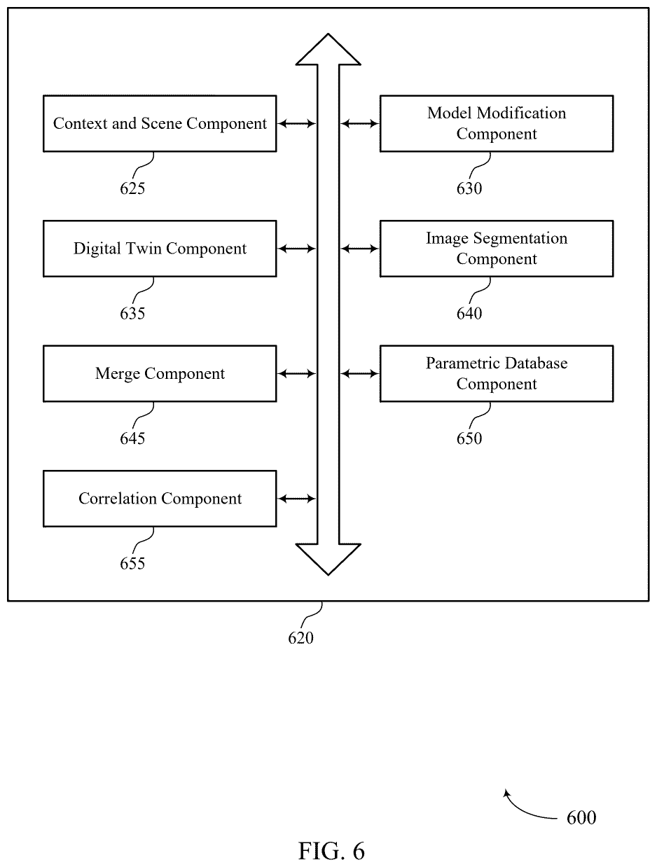

FIG. 6 shows a block diagram 600 of a communications manager 620 that supports improving 3D model quality by using common knowledge in accordance with one or more aspects of the present disclosure. The communications manager 620 may be an example of aspects of a communications manager 420, a communications manager 520, or both, as described herein. The communications manager 620, or various components thereof, may be an example of means for performing various aspects of improving 3D model quality by using common knowledge as described herein. For example, the communications manager 620 may include a context and scene component 625, a model modification component 630, a digital twin component 635, an image segmentation component 640, a merge component 645, a parametric database component 650, a correlation component 655, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

Additionally, or alternatively, the communications manager 620 may support 3D model creation in accordance with examples as disclosed herein. The context and scene component 625 is capable of, configured to, or operable to support a means for obtaining, from an original model of a scene, context and scene information associated with a first 3D object included in the scene, the scene including a geographic area, a second 3D object, or both. The model modification component 630 is capable of, configured to, or operable to support a means for generating, in accordance with the context and scene information, an updated model of the first 3D object, where the updated model of the first 3D object includes one or more first parameters associated with physical properties of the first 3D object that are modified relative to one or more second parameters included in the original model based on a set of multiple modified parameters obtained, from a parametric database including parametric information associated with a set of multiple candidate objects, using the context and scene information. The digital twin component 635 is capable of, configured to, or operable to support a means for outputting a digital twin associated with the scene and including the updated model of the first 3D object.

In some examples, to support obtaining the context and scene information, the context and scene component 625 is capable of, configured to, or operable to support a means for obtaining a type of the first 3D object, a name of the first 3D object, a relative position of the first 3D object within the scene, a physical location of the scene, a type of the scene, or any combination thereof.

In some examples, to support generating the updated model of the first 3D object, the image segmentation component 640 is capable of, configured to, or operable to support a means for generating one or more image segmentation masks associated with the first 3D object based on a set of multiple images of the scene, where the one or more image segmentation masks include labels associated with the first 3D object. In some examples, to support generating the updated model of the first 3D object, the image segmentation component 640 is capable of, configured to, or operable to support a means for obtaining associations between the one or more image segmentation masks and a 3D model associated with the scene. In some examples, to support generating the updated model of the first 3D object, the merge component 645 is capable of, configured to, or operable to support a means for merging the labels associated with the first 3D object from the one or more image segmentation masks with the 3D model, where the context and scene information indicates whether the context and scene information is associated with the one or more image segmentation masks or is associated with the 3D model after merging, and where generating the updated model includes modifying one or more properties of the 3D model after generating the one or more image segmentation masks, after merging the labels associated with the first 3D object with the 3D model, or both based on the context and scene information.

In some examples, the parametric database component 650 is capable of, configured to, or operable to support a means for transmitting a query to the parametric database, the query including the context and scene information. In some examples, the parametric database component 650 is capable of, configured to, or operable to support a means for obtaining, in accordance with the query, the set of multiple modified parameters associated with the physical properties of the first 3D object, where the set of multiple modified parameters includes parameters associated with a shape of the first 3D object, a color of the first 3D object, dimensions of the first 3D object, a type of the first 3D object, a type of material included in the first 3D object, or any combination thereof.

In some examples, the parametric database component 650 is capable of, configured to, or operable to support a means for transmitting a query to the parametric database, the query including the context and scene information. In some examples, the parametric database component 650 is capable of, configured to, or operable to support a means for obtaining, in accordance with the query, the set of multiple modified parameters associated with the physical properties of the first 3D object. In some examples, the correlation component 655 is capable of, configured to, or operable to support a means for selecting the one or more first parameters from among the set of multiple modified parameters in accordance with a correlation between one or more original parameters associated with the original model of the first 3D object and the one or more first parameters.

In some examples, to support generating the updated model of the first 3D object, the model modification component 630 is capable of, configured to, or operable to support a means for removing, supplementing, or adjusting one or more 3D models from the original model of the scene based on the set of multiple modified parameters.

In some examples, the set of multiple modified parameters indicate that the physical properties of the first 3D object in the original model are to be modified according to a geometric transformation, one or more deformations, one or more morphological operations, one or more free-form deformations, one or more surface modifications, one or more volumetric modifications, one or more subdividing modifications, one or more redefining modifications, one or more remeshing modifications, one or more decimating modifications, or any combination thereof. In some examples, the one or more first parameters are generated based on a modification of the one or more second parameters according to the set of multiple modified parameters.

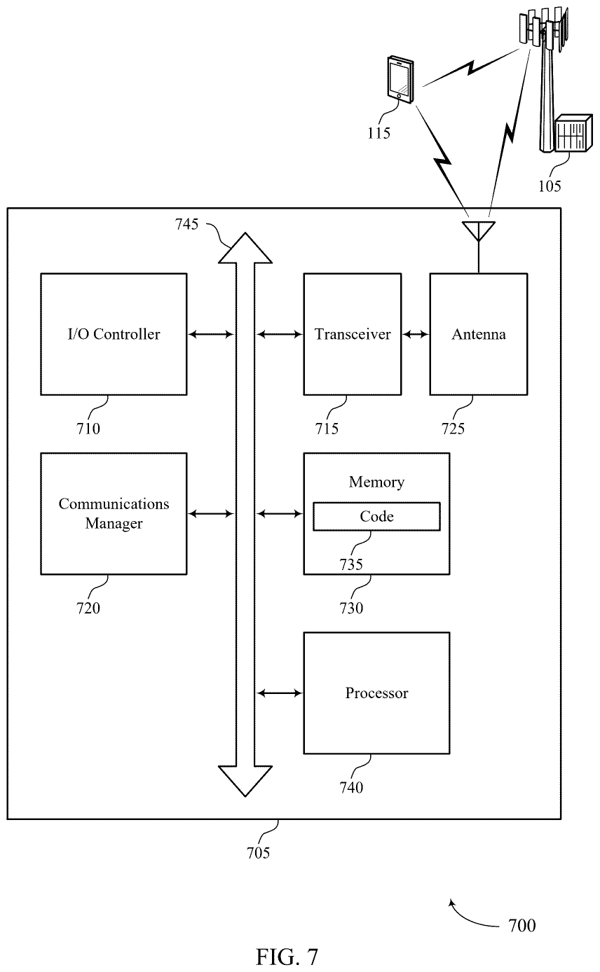

FIG. 7 shows a diagram of a system 700 including a device 705 that supports improving 3D model quality by using common knowledge in accordance with one or more aspects of the present disclosure. The device 705 may be an example of or include components of a device 405, a device 505, or a UE 115 as described herein. The device 705 may communicate (e.g., wirelessly) with one or more other devices (e.g., network entities 105, UEs 115, or a combination thereof). The device 705 may include components for bi-directional voice and data communications including components for transmitting and receiving communications, such as a communications manager 720, an input/output (I/O) controller, such as an I/O controller 710, a transceiver 715, one or more antennas 725, at least one memory 730, code 735, and at least one processor 740. These components may be in electronic communication or otherwise coupled (e.g., operatively, communicatively, functionally, electronically, electrically) via one or more buses (e.g., a bus 745).

The I/O controller 710 may manage input and output signals for the device 705. The I/O controller 710 may also manage peripherals not integrated into the device 705. In some cases, the I/O controller 710 may represent a physical connection or port to an external peripheral. In some cases, the I/O controller 710 may utilize an operating system such as iOS®, ANDROID®, MS-DOS®, MS-WINDOWS®, OS/2®, UNIX®, LINUX®, or another known operating system. Additionally, or alternatively, the I/O controller 710 may represent or interact with a modem, a keyboard, a mouse, a touchscreen, or a similar device. In some cases, the I/O controller 710 may be implemented as part of one or more processors, such as the at least one processor 740. In some cases, a user may interact with the device 705 via the I/O controller 710 or via hardware components controlled by the I/O controller 710.

In some cases, the device 705 may include a single antenna. However, in some other cases, the device 705 may have more than one antenna, which may be capable of concurrently transmitting or receiving multiple wireless transmissions. The transceiver 715 may communicate bi-directionally via the one or more antennas 725 using wired or wireless links as described herein. For example, the transceiver 715 may represent a wireless transceiver and may communicate bi-directionally with another wireless transceiver. The transceiver 715 may also include a modem to modulate the packets, to provide the modulated packets to one or more antennas 725 for transmission, and to demodulate packets received from the one or more antennas 725. The transceiver 715, or the transceiver 715 and one or more antennas 725, may be an example of a transmitter 415, a transmitter 515, a receiver 410, a receiver 510, or any combination thereof or component thereof, as described herein.

The at least one memory 730 may include random access memory (RAM) and read-only memory (ROM). The at least one memory 730 may store computer-readable, computer-executable, or processor-executable code, such as the code 735. The code 735 may include instructions that, when executed by the at least one processor 740, cause the device 705 to perform various functions described herein. The code 735 may be stored in a non-transitory computer-readable medium such as system memory or another type of memory. In some cases, the code 735 may not be directly executable by the at least one processor 740 but may cause a computer (e.g., when compiled and executed) to perform functions described herein. In some cases, the at least one memory 730 may include, among other things, a basic I/O system (BIOS) which may control basic hardware or software operation such as the interaction with peripheral components or devices.

The at least one processor 740 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 740 may be configured to operate a memory array using a memory controller. In some other cases, a memory controller may be integrated into the at least one processor 740. The at least one processor 740 may be configured to execute computer-readable instructions stored in a memory (e.g., the at least one memory 730) to cause the device 705 to perform various functions (e.g., functions or tasks supporting improving 3D model quality by using common knowledge). For example, the device 705 or a component of the device 705 may include at least one processor 740 and at least one memory 730 coupled with or to the at least one processor 740, the at least one processor 740 and the at least one memory 730 configured to perform various functions described herein.

In some examples, the at least one processor 740 may include multiple processors and the at least one memory 730 may include multiple memories. One or more of the multiple processors may be coupled with one or more of the multiple memories, which may, individually or collectively, be configured to perform various functions described herein. In some examples, the at least one processor 740 may be a component of a processing system, which may refer to a system (such as a series) of machines, circuitry (including, for example, one or both of processor circuitry (which may include the at least one processor 740) and memory circuitry (which may include the at least one memory 730)), or components, that receives or obtains inputs and processes the inputs to produce, generate, or obtain a set of outputs. The processing system may be configured to perform one or more of the functions described herein. For example, the at least one processor 740 or a processing system including the at least one processor 740 may be configured to, configurable to, or operable to cause the device 705 to perform one or more of the functions described herein. Further, as described herein, being “configured to,” being “configurable to,” and being “operable to” may be used interchangeably and may be associated with a capability, when executing code 735 (e.g., processor-executable code) stored in the at least one memory 730 or otherwise, to perform one or more of the functions described herein.

Additionally, or alternatively, the communications manager 720 may support 3D model creation in accordance with examples as disclosed herein. For example, the communications manager 720 is capable of, configured to, or operable to support a means for obtaining, from an original model of a scene, context and scene information associated with a first 3D object included in the scene, the scene including a geographic area, a second 3D object, or both. The communications manager 720 is capable of, configured to, or operable to support a means for generating, in accordance with the context and scene information, an updated model of the first 3D object, where the updated model of the first 3D object includes one or more first parameters associated with physical properties of the first 3D object that are modified relative to one or more second parameters included in the original model based on a set of multiple modified parameters obtained, from a parametric database including parametric information associated with a set of multiple candidate objects, using the context and scene information. The communications manager 720 is capable of, configured to, or operable to support a means for outputting a digital twin associated with the scene and including the updated model of the first 3D object.

By including or configuring the communications manager 720 in accordance with examples as described herein, the device 705 may support techniques for improved reliability, reduced power consumption, more efficient utilization of resources, improved utilization of processing capability, improved accuracy for 3D modeling, or any combination thereof.

In some examples, the communications manager 720 may be configured to perform various operations (e.g., receiving, monitoring, transmitting) using or otherwise in cooperation with the transceiver 715, the one or more antennas 725, or any combination thereof. Although the communications manager 720 is illustrated as a separate component, in some examples, one or more functions described with reference to the communications manager 720 may be supported by or performed by the at least one processor 740, the at least one memory 730, the code 735, or any combination thereof. For example, the code 735 may include instructions executable by the at least one processor 740 to cause the device 705 to perform various aspects of improving 3D model quality by using common knowledge as described herein, or the at least one processor 740 and the at least one memory 730 may be otherwise configured to, individually or collectively, perform or support such operations.

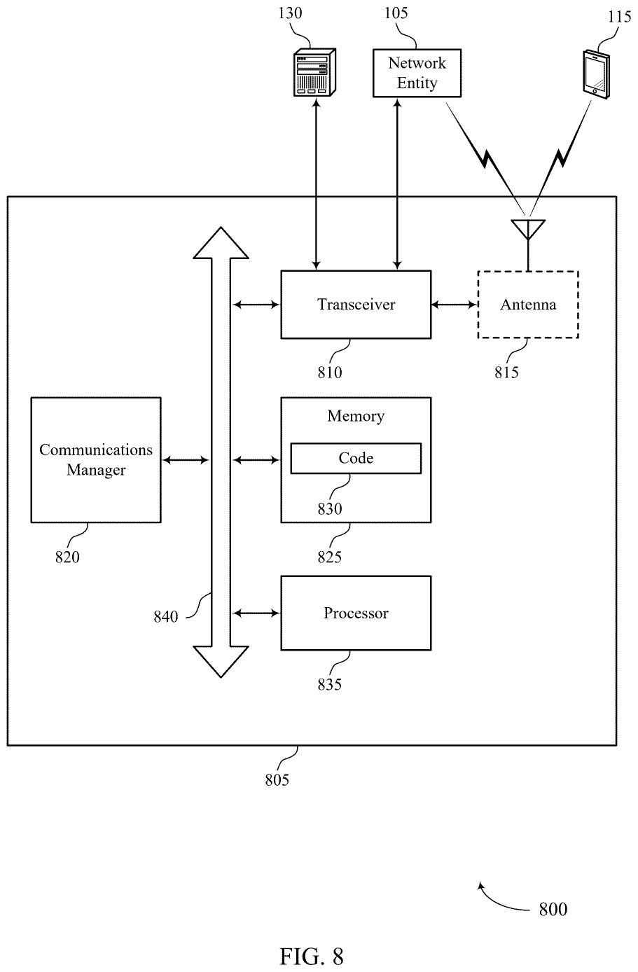

FIG. 8 shows a diagram of a system 800 including a device 805 that supports improving 3D model quality by using common knowledge in accordance with one or more aspects of the present disclosure. The device 805 may be an example of or include components of a device 405, a device 505, or a network entity 105 as described herein. The device 805 may communicate with other network devices or network equipment such as one or more of the network entities 105, UEs 115, or any combination thereof. The communications may include communications over one or more wired interfaces, over one or more wireless interfaces, or any combination thereof. The device 805 may include components that support outputting and obtaining communications, such as a communications manager 820, a transceiver 810, one or more antennas 815, at least one memory 825, code 830, and at least one processor 835. These components may be in electronic communication or otherwise coupled (e.g., operatively, communicatively, functionally, electronically, electrically) via one or more buses (e.g., a bus 840).

The transceiver 810 may support bi-directional communications via wired links, wireless links, or both as described herein. In some examples, the transceiver 810 may include a wired transceiver and may communicate bi-directionally with another wired transceiver. Additionally, or alternatively, in some examples, the transceiver 810 may include a wireless transceiver and may communicate bi-directionally with another wireless transceiver. In some examples, the device 805 may include one or more antennas 815, which may be capable of transmitting or receiving wireless transmissions (e.g., concurrently). The transceiver 810 may also include a modem to modulate signals, to provide the modulated signals for transmission (e.g., by one or more antennas 815, by a wired transmitter), to receive modulated signals (e.g., from one or more antennas 815, from a wired receiver), and to demodulate signals. In some implementations, the transceiver 810 may include one or more interfaces, such as one or more interfaces coupled with the one or more antennas 815 that are configured to support various receiving or obtaining operations, or one or more interfaces coupled with the one or more antennas 815 that are configured to support various transmitting or outputting operations, or a combination thereof. In some implementations, the transceiver 810 may include or be configured for coupling with one or more processors or one or more memory components that are operable to perform or support operations based on received or obtained information or signals, or to generate information or other signals for transmission or other outputting, or any combination thereof. In some implementations, the transceiver 810, or the transceiver 810 and the one or more antennas 815, or the transceiver 810 and the one or more antennas 815 and one or more processors or one or more memory components (e.g., the at least one processor 835, the at least one memory 825, or both), may be included in a chip or chip assembly that is installed in the device 805. In some examples, the transceiver 810 may be operable to support communications via one or more communications links (e.g., communication link(s) 125, backhaul communication link(s) 120, a midhaul communication link 162, a fronthaul communication link 168).

The at least one memory 825 may include RAM, ROM, or any combination thereof. The at least one memory 825 may store computer-readable, computer-executable, or processor-executable code, such as the code 830. The code 830 may include instructions that, when executed by one or more of the at least one processor 835, cause the device 805 to perform various functions described herein. The code 830 may be stored in a non-transitory computer-readable medium such as system memory or another type of memory. In some cases, the code 830 may not be directly executable by a processor of the at least one processor 835 but may cause a computer (e.g., when compiled and executed) to perform functions described herein. In some cases, the at least one memory 825 may include, among other things, a BIOS which may control basic hardware or software operation such as the interaction with peripheral components or devices. In some examples, the at least one processor 835 may include multiple processors and the at least one memory 825 may include multiple memories. One or more of the multiple processors may be coupled with one or more of the multiple memories which may, individually or collectively, be configured to perform various functions herein (for example, as part of a processing system).

The at least one processor 835 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 835 may be configured to operate a memory array using a memory controller. In some other cases, a memory controller may be integrated into one or more of the at least one processor 835. The at least one processor 835 may be configured to execute computer-readable instructions stored in a memory (e.g., one or more of the at least one memory 825) to cause the device 805 to perform various functions (e.g., functions or tasks supporting improving 3D model quality by using common knowledge). For example, the device 805 or a component of the device 805 may include at least one processor 835 and at least one memory 825 coupled with one or more of the at least one processor 835, the at least one processor 835 and the at least one memory 825 configured to perform various functions described herein. The at least one processor 835 may be an example of a cloud-computing platform (e.g., one or more physical nodes and supporting software such as operating systems, virtual machines, or container instances) that may host the functions (e.g., by executing code 830) to perform the functions of the device 805. The at least one processor 835 may be any one or more suitable processors capable of executing scripts or instructions of one or more software programs stored in the device 805 (such as within one or more of the at least one memory 825).

In some examples, the at least one processor 835 may include multiple processors and the at least one memory 825 may include multiple memories. One or more of the multiple processors may be coupled with one or more of the multiple memories, which may, individually or collectively, be configured to perform various functions herein. In some examples, the at least one processor 835 may be a component of a processing system, which may refer to a system (such as a series) of machines, circuitry (including, for example, one or both of processor circuitry (which may include the at least one processor 835) and memory circuitry (which may include the at least one memory 825)), or components, that receives or obtains inputs and processes the inputs to produce, generate, or obtain a set of outputs. The processing system may be configured to perform one or more of the functions described herein. For example, the at least one processor 835 or a processing system including the at least one processor 835 may be configured to, configurable to, or operable to cause the device 805 to perform one or more of the functions described herein. Further, as described herein, being “configured to,” being “configurable to,” and being “operable to” may be used interchangeably and may be associated with a capability, when executing code stored in the at least one memory 825 or otherwise, to perform one or more of the functions described herein.

In some examples, a bus 840 may support communications of (e.g., within) a protocol layer of a protocol stack. In some examples, a bus 840 may support communications associated with a logical channel of a protocol stack (e.g., between protocol layers of a protocol stack), which may include communications performed within a component of the device 805, or between different components of the device 805 that may be co-located or located in different locations (e.g., where the device 805 may refer to a system in which one or more of the communications manager 820, the transceiver 810, the at least one memory 825, the code 830, and the at least one processor 835 may be located in one of the different components or divided between different components).

In some examples, the communications manager 820 may manage aspects of communications with a core network 130 (e.g., via one or more wired or wireless backhaul links). For example, the communications manager 820 may manage the transfer of data communications for client devices, such as one or more UEs 115. In some examples, the communications manager 820 may manage communications with one or more other network entities 105, and may include a controller or scheduler for controlling communications with UEs 115 (e.g., in cooperation with the one or more other network devices). In some examples, the communications manager 820 may support an X2 interface within an LTE/LTE-A wireless communications network technology to provide communication between network entities 105.

Additionally, or alternatively, the communications manager 820 may support 3D model creation in accordance with examples as disclosed herein. For example, the communications manager 820 is capable of, configured to, or operable to support a means for obtaining, from an original model of a scene, context and scene information associated with a first 3D object included in the scene, the scene including a geographic area, a second 3D object, or both. The communications manager 820 is capable of, configured to, or operable to support a means for generating, in accordance with the context and scene information, an updated model of the first 3D object, where the updated model of the first 3D object includes one or more first parameters associated with physical properties of the first 3D object that are modified relative to one or more second parameters included in the original model based on a set of multiple modified parameters obtained, from a parametric database including parametric information associated with a set of multiple candidate objects, using the context and scene information. The communications manager 820 is capable of, configured to, or operable to support a means for outputting a digital twin associated with the scene and including the updated model of the first 3D object.

By including or configuring the communications manager 820 in accordance with examples as described herein, the device 805 may support techniques for improved reliability, reduced power consumption, more efficient utilization of resources, improved utilization of processing capability, improved accuracy for 3D modeling, or any combination thereof.

In some examples, the communications manager 820 may be configured to perform various operations (e.g., receiving, obtaining, monitoring, outputting, transmitting) using or otherwise in cooperation with the transceiver 810, the one or more antennas 815 (e.g., where applicable), or any combination thereof. Although the communications manager 820 is illustrated as a separate component, in some examples, one or more functions described with reference to the communications manager 820 may be supported by or performed by the transceiver 810, one or more of the at least one processor 835, one or more of the at least one memory 825, the code 830, or any combination thereof (for example, by a processing system including at least a portion of the at least one processor 835, the at least one memory 825, the code 830, or any combination thereof). For example, the code 830 may include instructions executable by one or more of the at least one processor 835 to cause the device 805 to perform various aspects of improving 3D model quality by using common knowledge as described herein, or the at least one processor 835 and the at least one memory 825 may be otherwise configured to, individually or collectively, perform or support such operations.

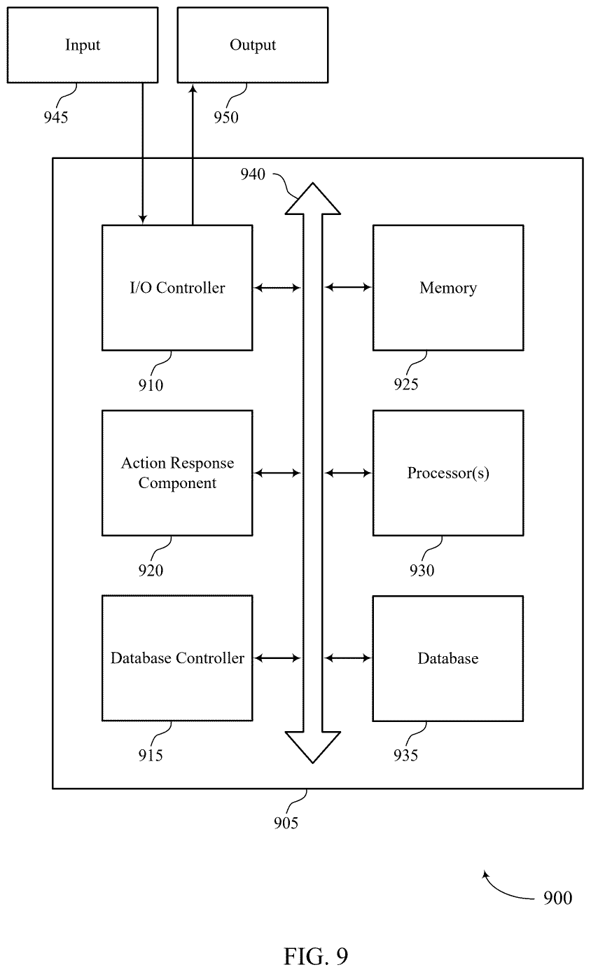

FIG. 9 shows a diagram of a system 900 including a device 905 that supports improving 3D model quality by using common knowledge in accordance with one or more aspects of the present disclosure. The device 905 may be an example of or include components of a device 405, a device 505, or a computing device as described herein. The device 905 may include components for bi-directional voice and data communications including components for transmitting and receiving communications, such as an action response component 920, an I/O controller, such as an I/O controller 910, a database controller 915, at least one memory 925, at least one processor 930, and a database 935. These components may be in electronic communication or otherwise coupled (e.g., operatively, communicatively, functionally, electronically, electrically) via one or more buses (e.g., a bus 940).

The I/O controller 910 may manage input signals 945 and output signals 950 for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor. In some examples, a user may interact with the device 905 via the I/O controller 910 or via hardware components controlled by the I/O controller 910.

The database controller 915 may manage data storage and processing in a database 935. The database 935 may be external to the device 905, temporarily or permanently connected to the device 905, or a data storage component of the device 905. In some cases, a user may interact with the database controller 915. In some other cases, the database controller 915 may operate automatically without user interaction. The database 935 may be an example of a persistent data store, a single database, a distributed database, multiple distributed databases, a database management system, or an emergency backup database.

Memory 925 may include random-access memory (RAM) and ROM. The memory 925 may store computer-readable, computer-executable software including instructions that, when executed, cause the processor to perform various functions described herein. In some cases, the memory 925 may contain, among other things, a BIOS which may control basic hardware or software operation such as the interaction with peripheral components or devices.

The processor 930 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 930 may be configured to operate a memory array using a memory controller. In some other cases, a memory controller may be integrated into the processor 930. The processor 930 may be configured to execute computer-readable instructions stored in memory 925 to perform various functions (e.g., functions or tasks supporting improving 3D model quality by using common knowledge).

Additionally, or alternatively, the action response component 920 may support 3D model creation in accordance with examples as disclosed herein. For example, the action response component 920 is capable of, configured to, or operable to support a means for obtaining, from an original model of a scene, context and scene information associated with a first 3D object included in the scene, the scene including a geographic area, a second 3D object, or both. The action response component 920 is capable of, configured to, or operable to support a means for generating, in accordance with the context and scene information, an updated model of the first 3D object, where the updated model of the first 3D object includes one or more first parameters associated with physical properties of the first 3D object that are modified relative to one or more second parameters included in the original model based on a set of multiple modified parameters obtained, from a parametric database including parametric information associated with a set of multiple candidate objects, using the context and scene information. The action response component 920 is capable of, configured to, or operable to support a means for outputting a digital twin associated with the scene and including the updated model of the first 3D object.

By including or configuring the action response component 920 in accordance with examples as described herein, the device 905 may support techniques for improved reliability, reduced power consumption, more efficient utilization of resources, improved utilization of processing capability, improved accuracy for 3D modeling, or any combination thereof.

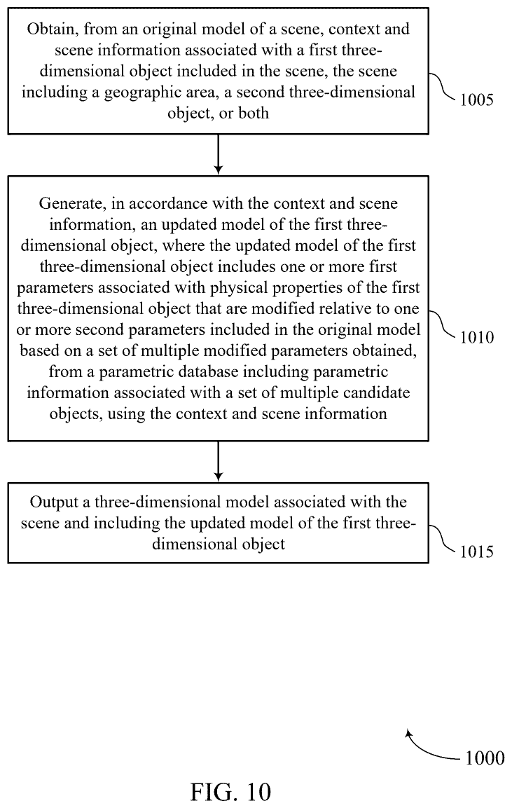

FIG. 10 shows a flowchart illustrating a method 1000 that supports improving 3D model quality by using common knowledge in accordance with one or more aspects of the present disclosure. The operations of the method 1000 may be implemented by a UE, a network entity, or a computing device or its components as described herein. For example, the operations of the method 1000 may be performed by a UE 115, a network entity, or a computing device as described with reference to FIGS. 1 through 9. In some examples, a UE, a network entity, or a computing device may execute a set of instructions to control the functional elements of the UE, the network entity, or the computing device to perform the described functions. Additionally, or alternatively, the UE, the network entity, or the computing device may perform aspects of the described functions using special-purpose hardware.

At 1005, the method may include obtaining, from an original model of a scene, context and scene information associated with a first 3D object included in the scene, the scene including a geographic area, a second 3D object, or both. The operations of 1005 may be performed in accordance with examples as disclosed herein. In some examples, aspects of the operations of 1005 may be performed by a context and scene component 625 as described with reference to FIG. 6.

At 1010, the method may include generating, in accordance with the context and scene information, an updated model of the first 3D object, where the updated model of the first 3D object includes one or more first parameters associated with physical properties of the first 3D object that are modified relative to one or more second parameters included in the original model based on a set of multiple modified parameters obtained, from a parametric database including parametric information associated with a set of multiple candidate objects, using the context and scene information. The operations of 1010 may be performed in accordance with examples as disclosed herein. In some examples, aspects of the operations of 1010 may be performed by a model modification component 630 as described with reference to FIG. 6.

At 1015, the method may include outputting a 3D model associated with the scene and including the updated model of the first 3D object. The operations of 1015 may be performed in accordance with examples as disclosed herein. In some examples, aspects of the operations of 1015 may be performed by a 3D model component 635 as described with reference to FIG. 6.

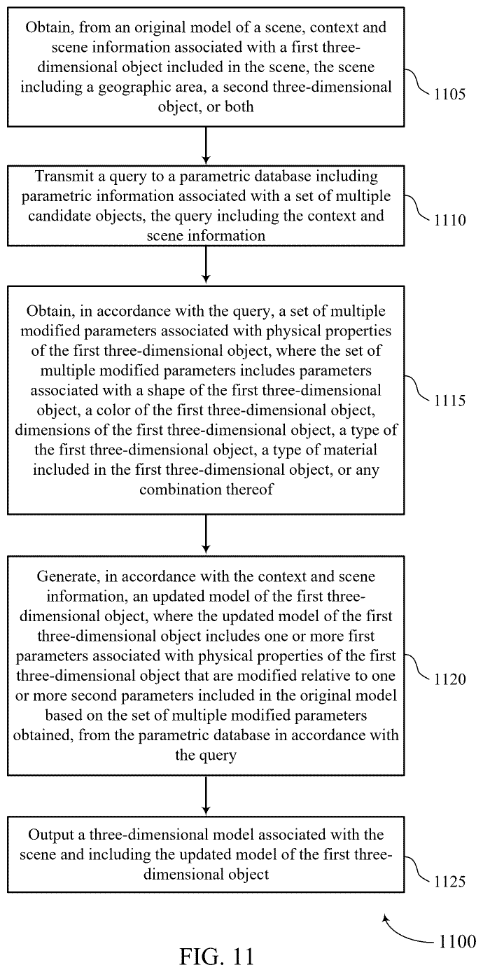

FIG. 11 shows a flowchart illustrating a method 1100 that supports improving 3D model quality by using common knowledge in accordance with one or more aspects of the present disclosure. The operations of the method 1100 may be implemented by a UE, a network entity, or a computing device or its components as described herein. For example, the operations of the method 1100 may be performed by a UE 115, a network entity, or a computing device as described with reference to FIGS. 1 through 9. In some examples, a UE, a network entity, or a computing device may execute a set of instructions to control the functional elements of the UE, the network entity, or the computing device to perform the described functions. Additionally, or alternatively, the UE, the network entity, or the computing device may perform aspects of the described functions using special-purpose hardware.

At 1105, the method may include obtaining, from an original model of a scene, context and scene information associated with a first 3D object included in the scene, the scene including a geographic area, a second 3D object, or both. The operations of 1105 may be performed in accordance with examples as disclosed herein. In some examples, aspects of the operations of 1105 may be performed by a context and scene component 625 as described with reference to FIG. 6.

At 1110, the method may include transmitting a query to a parametric database including parametric information associated with a set of multiple candidate objects, the query including the context and scene information. The operations of 1110 may be performed in accordance with examples as disclosed herein. In some examples, aspects of the operations of 1110 may be performed by a parametric database component 650 as described with reference to FIG. 6.

At 1115, the method may include obtaining, in accordance with the query, a set of multiple modified parameters associated with physical properties of the first 3D object, where the set of multiple modified parameters includes parameters associated with a shape of the first 3D object, a color of the first 3D object, dimensions of the first 3D object, a type of the first 3D object, a type of material included in the first 3D object, or any combination thereof. The operations of 1115 may be performed in accordance with examples as disclosed herein. In some examples, aspects of the operations of 1115 may be performed by a parametric database component 650 as described with reference to FIG. 6.

At 1120, the method may include generating, in accordance with the context and scene information, an updated model of the first 3D object, where the updated model of the first 3D object includes one or more first parameters associated with physical properties of the first 3D object that are modified relative to one or more second parameters included in the original model based on the set of multiple modified parameters obtained, from a parametric database, in accordance with the query. The operations of 1120 may be performed in accordance with examples as disclosed herein. In some examples, aspects of the operations of 1120 may be performed by a model modification component 630 as described with reference to FIG. 6.

At 1125, the method may include outputting a 3D model associated with the scene and including the updated model of the first 3D object. The operations of 1125 may be performed in accordance with examples as disclosed herein. In some examples, aspects of the operations of 1125 may be performed by a 3D model component 635 as described with reference to FIG. 6.

The following provides an overview of aspects of the present disclosure:

Aspect 1: A method for 3D model creation, comprising: obtaining, from an original model of a scene, context and scene information associated with a first 3D object included in the scene, the scene comprising a geographic area, a second 3D object, or both; generating, in accordance with the context and scene information, an updated model of the first 3D object, wherein the updated model of the first 3D object comprises one or more first parameters associated with physical properties of the first 3D object that are modified relative to one or more second parameters included in the original model based at least in part on a plurality of modified parameters obtained, from a parametric database comprising parametric information associated with a plurality of candidate objects, using the context and scene information; and outputting a 3D model associated with the scene and including the updated model of the first 3D object.

Aspect 2: The method of aspect 1, wherein obtaining the context and scene information comprises: obtaining a type of the first 3D object, a name of the first 3D object, a relative position of the first 3D object within the scene, a physical location of the scene, a type of the scene, or any combination thereof.

Aspect 3: The method of any of aspects 1 through 2, wherein generating the updated model of the first 3D object comprises: generating one or more image segmentation masks associated with the first 3D object based at least in part on a plurality of images of the scene, wherein the one or more image segmentation masks comprise labels associated with the first 3D object; obtaining associations between the one or more image segmentation masks and a 3D model associated with the scene; and merging the labels associated with the first 3D object from the one or more image segmentation masks with the 3D model, wherein the context and scene information indicates whether the context and scene information is associated with the one or more image segmentation masks or is associated with the 3D model after merging, and wherein generating the updated model comprises modifying one or more properties of the 3D model after generating the one or more image segmentation masks, after merging the labels associated with the first 3D object with the 3D model, or both based at least in part on the context and scene information.

Aspect 4: The method of any of aspects 1 through 3, further comprising: transmitting a query to the parametric database, the query comprising the context and scene information; and obtaining, in accordance with the query, the plurality of modified parameters associated with the physical properties of the first 3D object, wherein the plurality of modified parameters comprises parameters associated with a shape of the first 3D object, a color of the first 3D object, dimensions of the first 3D object, a type of the first 3D object, a type of material included in the first 3D object, or any combination thereof.

Aspect 5: The method of any of aspects 1 through 3, further comprising: transmitting a query to the parametric database, the query comprising the context and scene information; obtaining, in accordance with the query, the plurality of modified parameters associated with the physical properties of the first 3D object; and selecting the one or more first parameters from among the plurality of modified parameters in accordance with a correlation between one or more original parameters associated with the original model of the first 3D object and the one or more first parameters.

Aspect 6: The method of any of aspects 1 through 5, wherein generating the updated model of the first 3D object comprises: removing, supplementing, or adjusting one or more 3D models from the original model of the scene based at least in part on the plurality of modified parameters.

Aspect 7: The method of any of aspects 1 through 6, wherein the plurality of modified parameters indicate that the physical properties of the first 3D object in the original model are to be modified according to a geometric transformation, one or more deformations, one or more morphological operations, one or more free-form deformations, one or more surface modifications, one or more volumetric modifications, one or more subdividing modifications, one or more redefining modifications, one or more remeshing modifications, one or more decimating modifications, or any combination thereof, and the one or more first parameters are generated based at least in part on a modification of the one or more second parameters according to the plurality of modified parameters.

Aspect 8: An apparatus, comprising a processing system that includes processor circuitry and memory circuitry that stores code, the processing system configured to cause the apparatus to perform a method of any of aspects 1 through 7.

Aspect 9: An apparatus, comprising at least one means for performing a method of any of aspects 1 through 7.

Aspect 10: A non-transitory computer-readable medium storing code, the code comprising instructions executable by one or more processors to perform a method of any of aspects 1 through 7.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus, comprising:
a processing system that includes processor circuitry and memory circuitry that stores code, the processing system configured to cause the apparatus to:
obtain, from an original model of a scene, context and scene information associated with a first three-dimensional object included in the scene, the scene comprising a geographic area, a second three-dimensional object, or both;
generate, in accordance with the context and scene information, an updated model of the first three-dimensional object, wherein the updated model of the first three-dimensional object comprises one or more first parameters associated with physical properties of the first three-dimensional object that are modified relative to one or more second parameters included in the original model based at least in part on a plurality of modified parameters obtained, from a parametric database comprising parametric information associated with a plurality of candidate objects, using the context and scene information; and
output a three-dimensional model associated with the scene and including the updated model of the first three-dimensional object.

2. The apparatus of claim 1, wherein, to obtain the context and scene information, the processing system is configured to cause the apparatus to:
obtain a type of the first three-dimensional object, a name of the first three-dimensional object, a relative position of the first three-dimensional object within the scene, a physical location of the scene, a type of the scene, or any combination thereof.

3. The apparatus of claim 1, wherein, to generate the updated model of the first three-dimensional object, the processing system is configured to cause the apparatus to:
generate one or more image segmentation masks associated with the first three-dimensional object based at least in part on a plurality of images of the scene, wherein the one or more image segmentation masks comprise labels associated with the first three-dimensional object;
obtain associations between the one or more image segmentation masks and a three-dimensional model associated with the scene; and
merge the labels associated with the first three-dimensional object from the one or more image segmentation masks with the three-dimensional model, wherein the context and scene information indicates whether the context and scene information is associated with the one or more image segmentation masks or is associated with the three-dimensional model after merging, and wherein generating the updated model comprises modifying one or more properties of the three-dimensional model after generating the one or more image segmentation masks, after merging the labels associated with the first three-dimensional object with the three-dimensional model, or both based at least in part on the context and scene information.

4. The apparatus of claim 1, wherein the processing system is further configured to cause the apparatus to:
transmit a query to the parametric database, the query comprising the context and scene information; and
obtain, in accordance with the query, the plurality of modified parameters associated with the physical properties of the first three-dimensional object, wherein the plurality of modified parameters comprises parameters associated with a shape of the first three-dimensional object, a color of the first three-dimensional object, dimensions of the first three-dimensional object, a type of the first three-dimensional object, a type of material included in the first three-dimensional object, or any combination thereof.

5. The apparatus of claim 1, wherein the processing system is further configured to cause the apparatus to:
transmit a query to the parametric database, the query comprising the context and scene information;
obtain, in accordance with the query, the plurality of modified parameters associated with the physical properties of the first three-dimensional object; and
select the one or more first parameters from among the plurality of modified parameters in accordance with a correlation between one or more original parameters associated with the original model of the first three-dimensional object and the one or more first parameters.

6. The apparatus of claim 1, wherein, to generate the updated model of the first three-dimensional object, the processing system is configured to cause the apparatus to:
remove, supplement, or adjust one or more three-dimensional models from the original model of the scene based at least in part on the plurality of modified parameters.

7. The apparatus of claim 1, wherein:
the plurality of modified parameters indicate that the physical properties of the first three-dimensional object in the original model are to be modified according to a geometric transformation, one or more deformations, one or more morphological operations, one or more free-form deformations, one or more surface modifications, one or more volumetric modifications, one or more subdividing modifications, one or more redefining modifications, one or more remeshing modifications, one or more decimating modifications, or any combination thereof, and
the one or more first parameters are generated based at least in part on a modification of the one or more second parameters according to the plurality of modified parameters.

8. A method for three-dimensional model creation, comprising:
obtaining, from an original model of a scene, context and scene information associated with a first three-dimensional object included in the scene, the scene comprising a geographic area, a second three-dimensional object, or both;
generating, in accordance with the context and scene information, an updated model of the first three-dimensional object, wherein the updated model of the first three-dimensional object comprises one or more first parameters associated with physical properties of the first three-dimensional object that are modified relative to one or more second parameters included in the original model based at least in part on a plurality of modified parameters obtained, from a parametric database comprising parametric information associated with a plurality of candidate objects, using the context and scene information; and
outputting a three-dimensional model associated with the scene and including the updated model of the first three-dimensional object.

9. The method of claim 8, wherein obtaining the context and scene information comprises:
obtaining a type of the first three-dimensional object, a name of the first three-dimensional object, a relative position of the first three-dimensional object within the scene, a physical location of the scene, a type of the scene, or any combination thereof.

10. The method of claim 8, wherein generating the updated model of the first three-dimensional object comprises:
generating one or more image segmentation masks associated with the first three-dimensional object based at least in part on a plurality of images of the scene, wherein the one or more image segmentation masks comprise labels associated with the first three-dimensional object;
obtaining associations between the one or more image segmentation masks and a three-dimensional model associated with the scene; and
merging the labels associated with the first three-dimensional object from the one or more image segmentation masks with the three-dimensional model, wherein the context and scene information indicates whether the context and scene information is associated with the one or more image segmentation masks or is associated with the three-dimensional model after merging, and wherein generating the updated model comprises modifying one or more properties of the three-dimensional model after generating the one or more image segmentation masks, after merging the labels associated with the first three-dimensional object with the three-dimensional model, or both based at least in part on the context and scene information.

11. The method of claim 8, further comprising:
transmitting a query to the parametric database, the query comprising the context and scene information; and
obtaining, in accordance with the query, the plurality of modified parameters associated with the physical properties of the first three-dimensional object, wherein the plurality of modified parameters comprises parameters associated with a shape of the first three-dimensional object, a color of the first three-dimensional object, dimensions of the first three-dimensional object, a type of the first three-dimensional object, a type of material included in the first three-dimensional object, or any combination thereof.

12. The method of claim 8, further comprising:
transmitting a query to the parametric database, the query comprising the context and scene information;
obtaining, in accordance with the query, the plurality of modified parameters associated with the physical properties of the first three-dimensional object; and
selecting the one or more first parameters from among the plurality of modified parameters in accordance with a correlation between one or more original parameters associated with the original model of the first three-dimensional object and the one or more first parameters.

13. The method of claim 8, wherein generating the updated model of the first three-dimensional object comprises:
removing, supplementing, or adjusting one or more three-dimensional models from the original model of the scene based at least in part on the plurality of modified parameters.

14. The method of claim 8, wherein:
the plurality of modified parameters indicate that the physical properties of the first three-dimensional object in the original model are to be modified according to a geometric transformation, one or more deformations, one or more morphological operations, one or more free-form deformations, one or more surface modifications, one or more volumetric modifications, one or more subdividing modifications, one or more redefining modifications, one or more remeshing modifications, one or more decimating modifications, or any combination thereof, and
the one or more first parameters are generated based at least in part on a modification of the one or more second parameters according to the plurality of modified parameters.

15. A non-transitory computer-readable medium storing code for three-dimensional model creation, the code comprising instructions executable by one or more processors to:
obtain, from an original model of a scene, context and scene information associated with a first three-dimensional object included in the scene, the scene comprising a geographic area, a second three-dimensional object, or both;
generate, in accordance with the context and scene information, an updated model of the first three-dimensional object, wherein the updated model of the first three-dimensional object comprises one or more first parameters associated with physical properties of the first three-dimensional object that are modified relative to one or more second parameters included in the original model based at least in part on a plurality of modified parameters obtained, from a parametric database comprising parametric information associated with a plurality of candidate objects, using the context and scene information; and
output a three-dimensional model associated with the scene and including the updated model of the first three-dimensional object.

16. The non-transitory computer-readable medium of claim 15, wherein the instructions to obtain the context and scene information are executable by the one or more processors to:
obtain a type of the first three-dimensional object, a name of the first three-dimensional object, a relative position of the first three-dimensional object within the scene, a physical location of the scene, a type of the scene, or any combination thereof.

17. The non-transitory computer-readable medium of claim 15, wherein the instructions to generate the updated model of the first three-dimensional object are executable by the one or more processors to:
generate one or more image segmentation masks associated with the first three-dimensional object based at least in part on a plurality of images of the scene, wherein the one or more image segmentation masks comprise labels associated with the first three-dimensional object;
obtain associations between the one or more image segmentation masks and a three-dimensional model associated with the scene; and
merge the labels associated with the first three-dimensional object from the one or more image segmentation masks with the three-dimensional model, wherein the context and scene information indicates whether the context and scene information is associated with the one or more image segmentation masks or is associated with the three-dimensional model after merging, and wherein generating the updated model comprises modifying one or more properties of the three-dimensional model after generating the one or more image segmentation masks, after merging the labels associated with the first three-dimensional object with the three-dimensional model, or both based at least in part on the context and scene information.

18. The non-transitory computer-readable medium of claim 15, wherein the instructions are further executable by the one or more processors to:
transmit a query to the parametric database, the query comprising the context and scene information; and
obtain, in accordance with the query, the plurality of modified parameters associated with the physical properties of the first three-dimensional object, wherein the plurality of modified parameters comprises parameters associated with a shape of the first three-dimensional object, a color of the first three-dimensional object, dimensions of the first three-dimensional object, a type of the first three-dimensional object, a type of material included in the first three-dimensional object, or any combination thereof.

19. The non-transitory computer-readable medium of claim 15, wherein the instructions are further executable by the one or more processors to:
transmit a query to the parametric database, the query comprising the context and scene information;
obtain, in accordance with the query, the plurality of modified parameters associated with the physical properties of the first three-dimensional object; and
select the one or more first parameters from among the plurality of modified parameters in accordance with a correlation between one or more original parameters associated with the original model of the first three-dimensional object and the one or more first parameters.

20. The non-transitory computer-readable medium of claim 15, wherein the instructions to generate the updated model of the first three-dimensional object are executable by the one or more processors to:
remove, supplement, or adjust one or more three-dimensional models from the original model of the scene based at least in part on the plurality of modified parameters.
